(19) United States
(12) Patent Application Publication
(10) Pub. No.: US 2010/0164919 A1
(43) Pub. Date: Jul. 1, 2010

(54) LIQUID CRYSTAL DISPLAY DEVICE

(76) Inventors: Kazuhisa Yamamoto, Osaka (JP); Tetsuro Mizushima, Osaka (JP); Tatsuo Itoh, Osaka (JP); Kenichi Kasazumi, Osaka (JP); Shinichi Kadowaki, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/278,852

(22) PCT Filed: Feb. 7, 2007
(86) PCT No.: PCT/JP2007/052148

§ 371 Date: Aug. 8, 2008

(30) Foreign Application Priority Data
Feb. 9, 2006 (JP) 2006-032221

(51) Int. Cl. G02F 1/13357; G09G 3/36

(52) U.S. Cl. 345/207; 349/68

(57) ABSTRACT

Disclosed is a liquid crystal display device capable of performing image display with more adequate white level, during an operation of displaying an image which requires emphasizing white. A backlight illuminator for illuminating a liquid crystal display panel comprises a white light source adapted to generate white light, in addition to a laser source adapted to generate red light, blue light and green light. When an image to be displayed on a liquid crystal display panel requires emphasizing white, white light from the white light source is emitted to a liquid crystal display panel, in addition to red light, blue light and green light from the laser source. This makes it possible to display the image which requires emphasizing white, in the form of an image with more natural image quality.

### TECHNICAL FIELD

The present invention relates to a liquid crystal display device capable of performing color display with excellent color reproducibility.

### BACKGROUND ART

Heretofore, among liquid crystal display devices, an active matrix-type liquid crystal display device has been extensively used as a display device for personal computers and liquid crystal televisions. Along with this application, enlargement of a screen has been rapidly progressing. Furthermore, the active matrix-type liquid crystal display device is required to achieve a display with high definition, wide color reproduction range and high image quality, irrespective of size of a display screen. The reason is to more explicitly maintain its superiority in competition with other types of display devices, such as a plasma display panel (PDP). It is also required to achieve a reduction in power consumption.

With a view to reductions in power consumption and cost, efforts to increase a pixel aperture ratio have been made. However, the conventional active matrix-type liquid crystal display device has difficulty in increasing a pixel aperture ratio, for the following reason. In the conventional active matrix-type liquid crystal display device, red (R), green (G) and blue (B) color filters are provided on respective tops of sub-pixels making up each pixel, to allow white light from a backlight illuminator to pass therethrough so as to display a full-color image. That is, a full-color image is formed based on pixels each made up of the three R, G and B sub-pixels assembled together. Consequently, a resolution becomes one-third of that possessed by an actual total number of sub-pixels in the active matrix-type liquid crystal display device. Thus, it is necessary to form a high-definition pattern as a liquid crystal display device, whereas there is a restriction on increasing an aperture ratio of the pixels, due to the presence of a thin-film transistor (TFT), an electrode wiring and others to be formed in a pixel area. This causes a deterioration in utilization efficiency of illuminating light of the backlight illuminator to impose a restriction on the reduction in power consumption, because light never passes through the pixels in a quantity greater than that determined by an aperture ratio of a light-transmissive area of the sub-pixels.

Further, with a view to widening a color reproduction range and extending a lifetime, in place of a conventional backlight illuminator based on a cold cathode fluorescent tube, a backlight illuminator using a plurality of light-emitting diodes (LEDs) which include three primary color light-emitting diodes, i.e., a red light (R light)-emitting diode, a green light (G light)-emitting diode and a blue light (B light)-emitting diode, has been put into practical use. A light-emitting diode can provide a wider color reproduction range as compared with the cold cathode fluorescent tube, and thereby achieves a liquid crystal display device with higher image quality.

Furthermore, with a view to improving a pixel resolution, and efficiently utilizing illuminating light of a backlight illuminator to promote a reduction in power consumption, a field sequential driving scheme has been proposed. In summary, the field sequential driving scheme is configured, for example, such that one frame of image is time-divided into three pieces, and each of three light sources of R light, G light and B light is turned on during a duration of the ⅓ frame to display each of three images corresponding to the respective colors during the duration of the ⅓ frame.

In the field sequential driving scheme, R-light, G-light and B-light sources, e.g., R-light, G-light and B-light LED sources, are turned on in sequence during an R-light ON duration, a G-light ON duration and a B-light ON duration, respectively. During the ON duration of the R-light LED, a video signal corresponding to red is supplied to a liquid crystal display panel, so that one screen of red image is written in the liquid crystal display panel to display the red image. During the ON duration of the G-light LED, a video signal corresponding to green is supplied to the liquid crystal display panel, so that one screen of green image is written in the liquid crystal display panel to display the green image. During the ON duration of the B-light LED, a video signal corresponding to blue is supplied to the liquid crystal display panel, so that one screen of blue image is written in the liquid crystal display panel to display the blue image. Based on the display of the three successive images, one frame is formed. The frame is repeated, for example, in a number of 60 frames/sec to display a full-color image. The field sequential driving scheme makes it possible to eliminate the need for the R, G and B color filters, and obtain a resolution three times greater than that of the conventional color liquid crystal display device. In addition, utilization efficiency of illuminating light of a backlight illuminator can be improved, and thereby there is a potential to achieve a reduction in power consumption.

However, this scheme has many problems to be solved, and thereby has not reached a stage of full-scale commercialization. There has been proposed an example (first example) for reducing a flicker phenomenon as one of the problems (see, for example, Patent Document 1). A driving scheme according to this proposal is configured such that one frame of image is divided into a plurality of sub-frames, and R-light, G-light and B-light backlights are turned in sequence in conjunction with displaying corresponding ones of red, green and blue images, during respective durations of the sub-frames, to emit R, G and B lights to a display section. This allegedly makes it possible to reduce the flicker phenomenon in a display screen which is one disadvantage of the field sequential driving scheme.

However, the field sequential driving scheme including the driving scheme of the above proposal is configured to switch between three colors at a high speed to perform a display operation. Thus, it is necessary to use a liquid crystal display panel capable of responding at a high speed. In terms of response speed, even a liquid crystal display panel using OCB (Optical Compensated Bend) mode liquid crystal having a relatively high response speed is not enough for the conventional field sequential driving scheme.

Further, in case of using LED sources adapted to generate at least three color lights consisting of R light, G light and B light, due to a variation in emission color between LEDs, even an emission color, for example, of G light, is likely to take on a red tinge or a blue tinge, depending on LEDs. Even in the same element, an emission color is likely to change due to a driving current, a temperature characteristic or other factor. In full-color display using the R-light, G-light and B-light LEDs, it is difficult to maintain a chromaticity of a white level constant. Moreover, although a chromaticity of the white level can be adjusted just after completion of fabrication of a liquid crystal display device, the white level will change on a long-term basis due to a variation in aging.

In connection with the above problem in using LEDs as light sources of a backlight illuminator, there has been proposed an example (second example) where a light source adapted to generate white light is used as one of a plurality of light sources in a light source section adapted to generate a plurality of lights different in wavelength characteristic (see, for example, Patent Document 2). Allegedly, the light source adapted to generate white light makes it possible to readily obtain a desired chromaticity of a white level, and suppress a change in the white level due to a changing factor, such as a temperature characteristic.

In the case of using LEDs, heat generation in each of the LEDs causes changes in emission wavelength and output power. Thus, even if brightness and tone are adjusted once, they will change after the adjustment. Such a change is also caused by aging. In this connection, there has been proposed a configuration for suppressing heat generation due to an increase in driving current to reduce a change in characteristics, wherein a semiconductor laser element suitable for providing higher output power with brightness greater than that of an LED is used as at least one of three-color light-emitting elements. This example (third example) specifically shows to use a red semiconductor laser (see, for example, Patent Document 3).

The above first example shows a field sequential driving scheme configured to switch between three colors at a high speed to display a full-color image. However, the conventional field sequential driving scheme including the first example is configured to switch between three colors at a high speed to perform a drive operation, and thereby it is necessary to use a liquid crystal display panel capable of responding to the drive operation at a high speed. In reality, even a currently-commercialized, high-speed response, OCB mode liquid crystal display panel has a problem of being unable to obtain adequate image quality, as compared with a typical conventional liquid crystal display panel.

The second example is a technique of performing a display operation correspondingly to sub-fields of a liquid crystal display panel, using four color lights consisting of R light, G light, B light and white light, as light sources, i.e., a field sequential driving scheme which includes white light as illuminating light. However, as long as the second example employs the field sequential driving scheme, the liquid crystal display panel is required to be a high-speed response type.

Although the third example describes that a red semiconductor laser is used as a light source of a backlight illuminator, a specific structure, configuration and other information thereof are not disclosed at all. Thus, it is not easy to practically realize the light source using the red semiconductor laser.

Further, each of the second and third examples is intended to primarily use an LED as a light source, and thereby it does not include any disclosure and suggestion about a structure, configuration and a strategy for increasing a white level, using a white light source and laser sources of three color lights consisting of R light, G light and B light. Thus, it is necessary to conduct further researches to practically realize the structure/configuration for increasing a white level.

Patent Document 1: JP 2000-199886A

Patent Document 2: JP 2004-4626A

Patent Document 3: JP 2005-64163A

### DISCLOSURE OF THE INVENTION

It is an object of the present invention to provide a liquid crystal display device capable of performing image display with more adequate white level, during an operation of displaying an image which requires emphasizing white, using a laser source for at least three color lights consisting of R light, G light and B light, and a light source adapted to generate white light.

According to one aspect of the present invention, there is provided a liquid crystal display device comprising a liquid crystal display panel, and a backlight illuminator adapted to illuminate the liquid crystal display panel from the side of a back surface thereof. The backlight illuminator includes a laser source adapted to generate at least red light, green light and blue light, and a white light source adapted to generate white light. The backlight illuminator is operable, when the liquid crystal display panel displays an image which requires emphasizing white, to increase an output intensity of the white light source.

In above liquid crystal display device, the laser source adapted to generate red light, green light and blue light is employed to allow a color reproduction range of images to be widened, and the white light source is employed to allow white when it is desired to emphasize a white level to be displayed with sufficient brightness. Thus, a higher quality image can be displayed as compared with a type using only a laser source.

### BRIEF DESCRIPTION OF DRAWINGS

FIG. 1A is a schematic top plan view showing a configuration of a liquid crystal display device according to a first embodiment of the present invention.

FIG. 1B is a schematic sectional view taken along the line A-A in FIG. 1A.

FIG. 2A is a schematic top plan view showing a configuration of a liquid crystal display panel in FIG. 1A.

FIG. 2B is a conceptual sectional view taken along the line B-B in FIG. 2A.

FIG. 3 is a timing chart showing a strategy for driving the liquid crystal display device according to the first embodiment (n=2).

FIG. 4A is a schematic top plan view showing a configuration of a liquid crystal display device according to a second embodiment of the present invention.

FIG. 4B is a schematic sectional view taken along the line A-A in FIG. 4A.

FIG. 5 is a conceptual sectional view showing a configuration of a liquid crystal display device according to a third embodiment of the present invention.

FIG. 6 is a conceptual sectional view showing a configuration of a liquid crystal display device according to a fourth embodiment of the present invention.

FIG. 7 is a conceptual sectional view showing a configuration of a liquid crystal display panel in FIG. 6.

FIG. 8A is a conceptual sectional view showing a configuration of one pixel of a liquid crystal display panel in a liquid crystal display device according to a fifth embodiment of the present invention.

FIG. 8B is a conceptual top plan view showing an arrangement of the four pixels in FIG. 8A.

FIG. 9 is a diagram for explaining one example where the pixel in the fifth embodiment is applied to the liquid crystal display panel in the first embodiment.

FIG. 10A is a schematic top plan view showing a configuration of a liquid crystal display device according to a sixth embodiment of the present invention.

FIG. 10B is a schematic sectional view taken along the line A-A in FIG. 10A.

FIG. 11 is a schematic sectional view showing a configuration for driving a white light source in FIGS. 10A and 10B.

FIG. 12A is a schematic top plan view showing a configuration of a liquid crystal display device according to a seventh embodiment of the present invention.

FIG. 12B is a schematic sectional view taken along the line A-A in FIG. 12A.

FIG. 13 is a schematic sectional view showing a configuration of a liquid crystal display device according to an eighth embodiment of the present invention.

### BEST MODE FOR CARRYING OUT THE INVENTION

With reference to the drawings, the present invention will now be described based on an embodiment thereof. In the following description, the same elements are defined by a common code, and their duplicated description will be omitted on a case-by-case basis. In figures, for the purpose of facilitating understanding, dimensions of a light source section and a liquid crystal panel are not accurately illustrated.

### First Embodiment

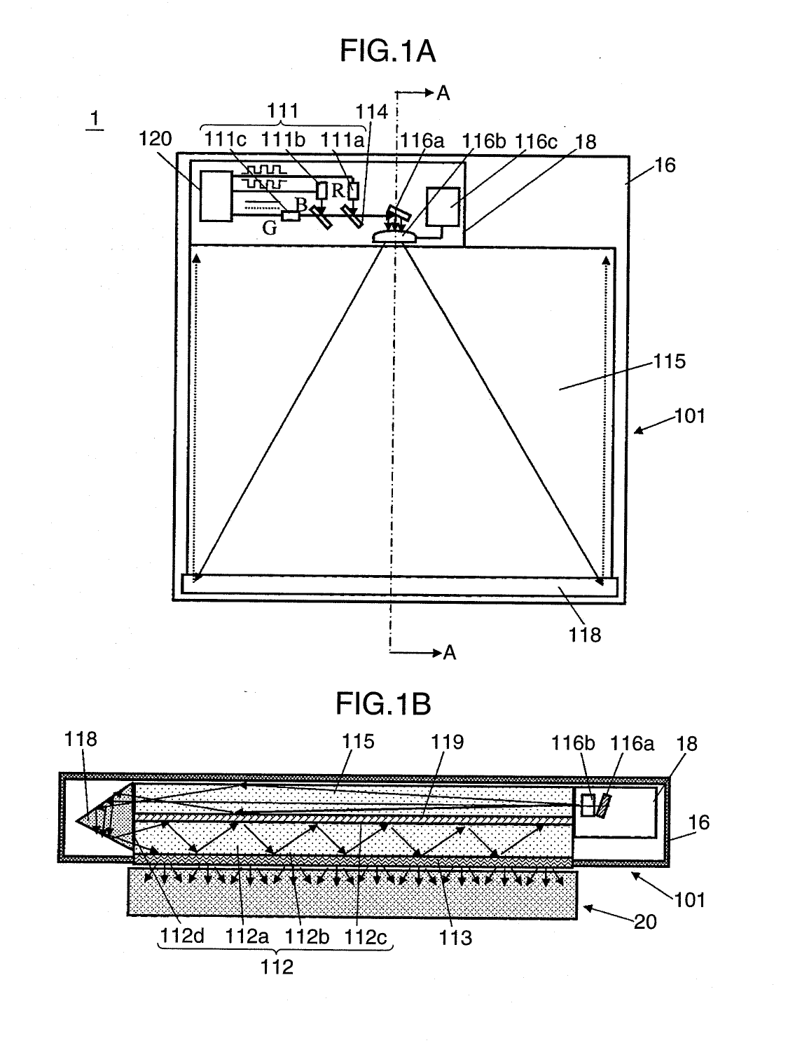

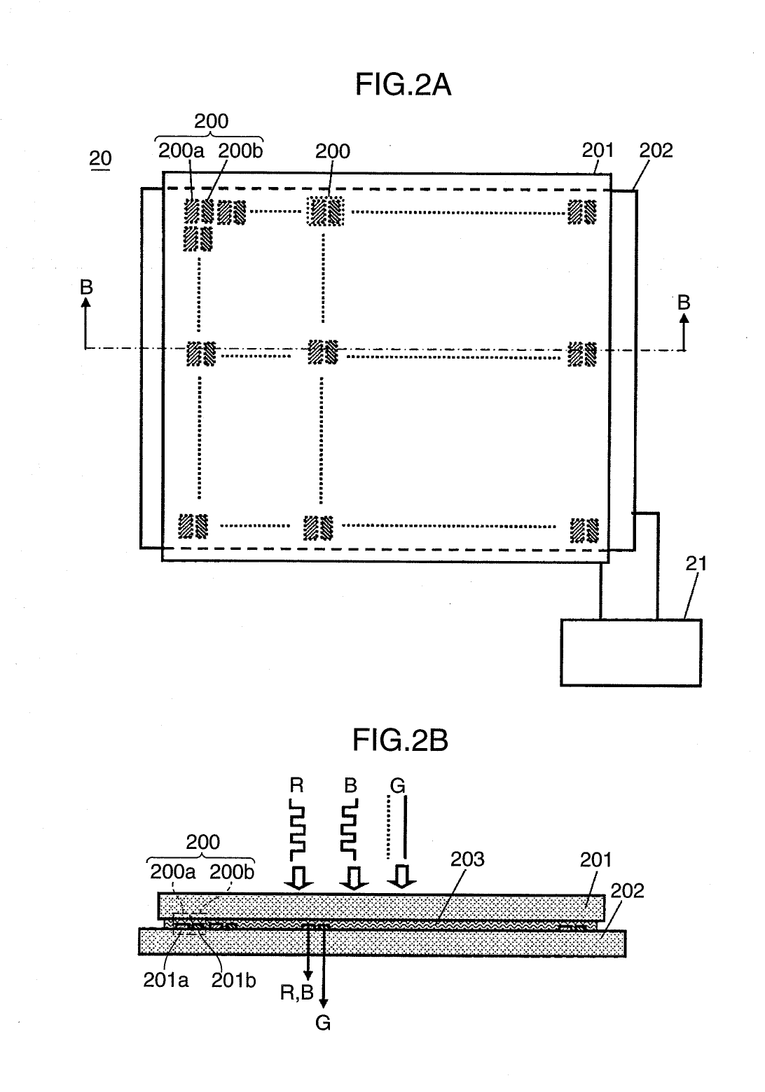

FIGS. 1A and 1B show a configuration of a liquid crystal display device 1 according to a first embodiment of the present invention, wherein FIG. 1A is a schematic top plan view showing an outline of the configuration of the liquid crystal display device 1, FIG. 1B is a schematic sectional view taken along the line A-A in FIG. 1A. In the illustration of the liquid crystal display device 1, respective surfaces of a housing 16 and a compartment 18 for receiving therein a light source are cut away to show an internal configuration in an easily understandable manner. FIGS. 2A and 2B are conceptual views for explaining a configuration of a liquid crystal display panel 20 for use in the liquid crystal display device 1 according to the first embodiment, wherein FIG. 2A is a schematic top plan view, and FIG. 2B is a conceptual sectional view taken along the line B-B in FIG. 2A. In FIGS. 2A and 2B, the same element as that in FIGS. 1A and 1B is defined by a common code. With reference to FIGS. 1A, 1B, 2A and 2B, the configuration of the liquid crystal display device 1 according to the first embodiment will be described below.

As shown in FIGS. 1A and 1B, the liquid crystal display device 1 according to the first embodiment comprises a light source section 101 adapted to emit R light, G light and B light, and a liquid crystal display panel 20 adapted to apply a voltage to liquid crystal thereof to display an image thereon. As shown in FIGS. 2A and 2B, in the liquid crystal display panel 20, a unit pixel 200 is made up of a first sub-pixel 200a and a second sub-pixel 200b. The first sub-pixel 200a has a first color filter 201a adapted to allow only any two of R, G and B lights to pass therethrough (the two lights will hereinafter be referred to as “first light” and “second light”), and the second sub-pixel 200b has a second color filter 201b adapted to allow only the remaining one light other than the two lights (the remaining one light will hereinafter be referred to as “third light”).

A drive control section 21 in FIG. 2A for the liquid crystal display panel 20 is operable to time-divide one frame of image into n pieces (n: an integer of two or more), and apply respective image information about the first and second lights to the first sub-pixel 200a during every duration of the 1/n frame, while applying image information about the third light to the second sub-pixel 200b during a duration of the one frame of image. The light source section 101 in FIG. 1A is operable to emit the first and second lights during every duration of the 1/n frame in synchronization with applying the respective image information about the first and second lights, while at least continuously demonstrating the third light during the duration of the one frame of image.

In the first embodiment, the number n for use in time-dividing the one frame of image is two. It is understood that the number n in the present invention is not limited to the specific number.

As shown in FIGS. 1A and 1B, the liquid crystal display device 1 according to the first embodiment will be described by taking a flat panel-type liquid crystal display device as an example. The liquid crystal display device 1 has at least the liquid crystal display panel 20 adapted to apply a voltage to the liquid crystal under control of the drive control section 21 to display an image thereon, and the light source section 101 adapted to emit at least R light, G light and B light to a back surface of the liquid crystal display panel 20. In the first embodiment, the light source section 101 is a backlight illuminator. Thus, the light source section 101 will be expressed as “backlight illuminator 101” in the following description.

In FIGS. 1A and 1B, the backlight illuminator 101 comprises a plurality of laser sources (LDs) 111, and a flat plate-shaped light-guiding plate 112 adapted to introduce laser light sent from each of the laser sources 111, from a first one 112d of opposite edge surfaces thereof, and, after guiding the introduced laser light through a transparent light-guiding portion 112a, uniformly emit the laser light from a first one 112b of opposite principal surfaces thereof in a planar pattern. Further, a diffuser plate 113 is provided on the side of the first principal surface 112b of the light-guiding plate 112 to diffuse light. In the first embodiment, a reflector plate 119 formed, for example, with a micro-dot pattern, is provided on the other, second, principal surface 112c of the light-guiding plate 112 to uniformly diffuse and reflect the entered laser light to direct the reflected laser light to the first principal surface 112b.

The backlight illuminator 101 further comprises an R light source 111a, a G light source 111c and a B light source 111b adapted to generate R light, G light and B light, respectively. Preferably, among these laser sources, a red semiconductor laser (LD) and a blue semiconductor laser (LD) adapted to generate R light and B light are used for the first and second lights, respectively, and a green SHG (Second Harmonic Generation)-semiconductor laser (LD) adapted to generate G light is used for the third light. A SHG is a sort of a nonlinear optical phenomenon, specifically a phenomenon that light (SHG light: frequency 2ω) having a frequency two times greater than that of light (fundamental light: frequency ω) entered in a medium occurs. When the green SHG-LD is used as the G light source 111c, G light can be stably generated, for example, by converting an infrared LD light into light having a green wavelength through means of the SHG (Second Harmonic Generation), and allowing the converted light to have a CW (Continuous Wave) operation.

One example of a specific configuration of the G light source 111c will be briefly described below. For example, G light having a wavelength of 532 nm can be produced by pumping a solid-state laser using a semiconductor laser to generate light having a wavelength of 1064 nm, confining the generated light in a resonator, and setting an SHG element in the resonator. Alternatively, G light having a wavelength of 532 nm can be produced by pumping a fiber laser using a semiconductor laser to generate light having a wavelength of 1064 nm, and introducing the generated light to an SHG element. These configurations can advantageously stabilize an output when a light source is used at a constant light intensity, i.e., under the CW operation, as in the first embodiment, although they are not suitable for use in a light source involving intensity modulation due to dull modulation. Just for reference, a typical semiconductor laser is capable of stably performing intensity modulation.

In the above laser source 111 comprising the R light source 111a, the G light source 111c and the B light source 111b, each of the light sources can be turned on based on a voltage having a given driving waveform from an after-mentioned laser source-driving circuit section 120, according to an after-mentioned driving strategy.

As one example of a technique of introducing laser light sent from the laser source 111, to the first edge surface of the light-guiding plate 112, laser lights sent from the R light source 111a, the G light source 111c and the B light source 111b are multiplexed together by a dichroic mirror 114, and the multiplexed lights are reflected by a reflecting mirror 116a. Then, a beam plane of the reflected lights is widened by a cylindrical lens 116b, and the widened lights are entered into the first edge surface 112d of the light-guiding plate 112. The cylindrical lens 116b may be reciprocatingly moved by a lens-driving circuit section 116c to scan the widened lights.

In the first embodiment, a light path-changing section 118 is provided on the side of the first edge surface 112d of the light-guiding plate 112 to change a light path of the lights from the laser source 111 in such a manner as to introduce the lights to the first edge surface 112d of the light-guiding plate 112. Further, an auxiliary light-guiding plate 115 is provided on the light-guiding plate 112 in a laminated manner, to guide the lights from the laser source 111 to the light path-changing section 118.

According to the after-mentioned driving strategy, the backlight illuminator 101 serving as a light source section is operable to alternately turn on the R light source 111a and the B light source 111b while simultaneously turning on the G light source 111c, to uniformly emit the R, G and B laser lights toward the back surface of the liquid crystal display panel 20 in a planar pattern. In the above manner, the backlight illuminator 101 can be formed as a flat panel-type configuration adapted to illuminate the liquid crystal display panel 20 from the back surface thereof, with a planar light emitted from the first principal surface 112b of the light-guiding plate 112.

As shown in FIGS. 2A and 2B, for example, an active matrix-type, high-speed response, OCB mode liquid crystal display panel is used as the liquid crystal display panel 20. In FIGS. 2A and 2B, some components, such as a driving thin-film transistor (TFT), a transparent electrode, an electrode wiring, a sealing portion and a polarizing plate, are omitted, for simplifying explanation.

The liquid crystal display panel 20 is a transmissive type or semi-transmissive-type, e.g., a TFT active matrix-type liquid crystal display panel. In the first embodiment, the plurality of pixels each made up of the first sub-pixel 200a for both red and blue, and the second sub-pixel 200b for green, as one unit pixel 200, are provided in a display region. A full-color image can be displayed by controlling drive of TFTs (not shown) provided in the respective pixels, by the drive control section 21. For example, an OCB mode liquid crystal layer 203 is provided between two transparent substrates 201, 202, in such a manner as to be oriented in a given direction. Each of the TFTs for driving the OCB mode liquid crystal layer 203 is formed in one of the two transparent substrates 201, 202, and the liquid crystal display panel 20 is sandwiched between a pair of polarizing plates (not shown). A conventionally used configuration may be used as a basic configuration of the liquid crystal display panel 20. Typically, a glass substrate is used as each of the transparent substrates 201, 202.

As shown in FIG. 2A, in the liquid crystal display panel 20, the unit pixel 200 formed between the transparent substrates 201, 202 is made up of the first sub-pixel 200a and the second sub-pixel 200b. That is, a unit pixel (single picture element) in a conventional liquid crystal display device is made up of three sub-pixels each having a color filter adapted to allow only a different one of R light, B light and G light to pass therethrough, whereas the unit pixel (single picture element) 200 of the liquid crystal display panel 20 in the liquid crystal display device according to the first embodiment is distinctively made up of two sub-pixels consisting of the first sub-pixel 200a and the second sub-pixel 200b.

As shown in FIG. 2B, in the liquid crystal display panel 20, the first sub-pixel 200a is provided with the first color filter 201a adapted to allow only any two of R, G and B lights (in the first embodiment, only R light and B light) to pass therethrough. The second sub-pixel 200b is provided with the second color filter 201b adapted to allow only the remaining one light other than the R and B lights, i.e., only G light, to pass therethrough. That is, a conventional liquid crystal display device is designed to arrange a plurality of unit pixels each made up of three sub-pixels having three types of color filters, i.e., R, G and B color filters, respectively. By contrast, in the liquid crystal display device 1 according to the first embodiment, two types of color filters, i.e., the first color filter 201a adapted to allow only R and B lights to pass therethrough, and the second color filter 201b adapted to allow only G light to pass therethrough, are distinctively provided to the first sub-pixel 200a and the second sub-pixel 200b, respectively.

According to the after-mentioned driving strategy, the alternate R and B lights and the continuous G light are emitted from the first principal surface 112b of the light-guiding plate 112 in the backlight illuminator 101, from the back surface of the liquid crystal display panel 20, in the form of a uniform planar light.

The drive control section 21 for the liquid crystal display panel 20 is operable, according to the after-mentioned driving strategy, to apply respective image information about R, G and B lights to corresponding ones of the first sub-pixel 200a and the second sub-pixel 200b. Respective image information about R and B lights are applied to the first sub-pixel 200a by the drive control section 21, and each of R light source 111a and the B light source 111b is operable to generate light in synchronization with a corresponding one of the image information. Thus, lights based on the respective image information about R and B lights are optically modulated at a high speed, and displayed from a display section. Further, image information about G light is applied to the second sub-pixel 200b by the drive control section 21, and the G light source 111c is operable to continuously generate light. Thus, light based on the image information about G light is displayed from the display section.

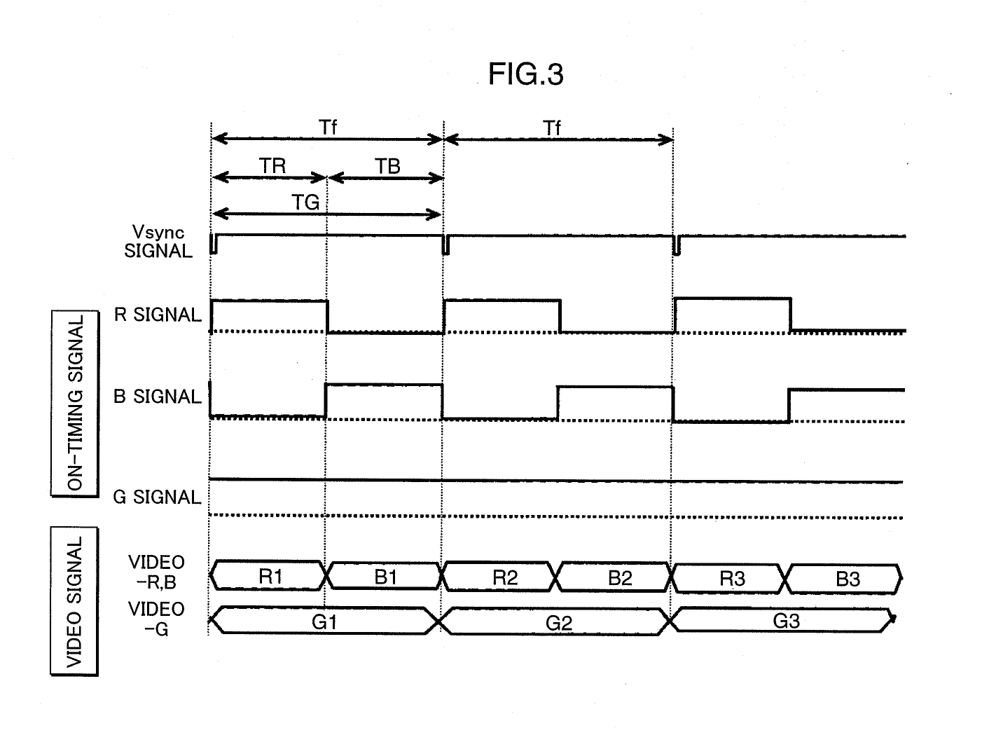

FIG. 3 is a timing chart showing a strategy for driving the liquid crystal display device 1 according to the first embodiment (n=2). A full-color image can be displayed by driving the liquid crystal display device 1 illustrated in FIG. 1A to 2B according to the timing chart illustrated in FIG. 3. The strategy will be specifically described below.

A Vsync signal is a signal for stating write-in of an image signal. An ON-timing signal for each of an R signal, a B signal and a G signal is a timing signal for turning on the light source of each of R light, G light and B light. Each of video signals, i.e., VIDEO-R, VIDEO-B and VIDEO-G, indicates an image signal for driving a corresponding one of the first sub-pixel 200a and the second sub-pixel 200b making up the unit pixel 200. Tf indicates a duration of one frame. TR, TG and TB indicate respective ON durations of the R, G and B light sources.

In FIG. 3, an image signal, e.g., R1 of the VIDEO-R, to be supplied to the first sub-pixel 200a of the liquid crystal display panel 20 by the drive control section 21 is a signal formed by compressing an original video signal input from the outside in association with red, in a direction of a time axis at a rate of one-half of one frame (Tf) (n=2). An image signal, e.g., G1 of the VIDEO-G, to be supplied to the second sub-pixel 200b of the liquid crystal display panel 20 by the drive control section 21 is an original video signal input from the outside in association with green. An image signal, e.g., B1 of the VIDEO-B, to be supplied to the first sub-pixel 200a of the liquid crystal display panel 20 by the drive control section 21 is a signal formed by compressing an original video signal input from the outside in association with blue, in the direction of the time axis at a rate of one-half of one frame (Tf) (n=2). That is, the drive control section 21 for the liquid crystal display panel 20 is operable to time-divide one frame (Tf) of image into two pieces (n=2), and apply respective image information about R and B lights to the first sub-pixel 200a, during every one of the ON durations TR, TB of the ½ frames, while applying image information about G light to the second sub-pixel 200b, during a duration of the one frame (Tf) of image, i.e., during the duration TG.

Further, the backlight illuminator 101 serving as a light source section is operable to alternately turn on the R light source 111a and the B light source 111b in the laser sources 111, during every one of the ON durations TR, TB of one-halves of the one frame (Tf) of image (n=2), while continuously turning on the G light source 111c during the duration of the one frame (Tf) of image, i.e., during the ON duration (TG).

In this manner, during the ON duration (TR) of the ½ frame in the R light source 111a, the video signal (R1) associated with red and compressed to ½ is applied to the first sub-pixel 200a of the liquid crystal display panel 20 in synchronization with the ON duration (TR) by the drive control section 21. Thus, one screen of red image is displayed through the first sub-pixel 200a provided with the first color filter 201a in the liquid crystal display panel 20.

Then, during the ON duration (TB) of the subsequent ½ frame in the B light source 111b, the video signal (B1) associated with blue and compressed to ½ is applied to the first sub-pixel 200a of the liquid crystal display panel 20 in synchronization with the ON duration (TB). Thus, one screen of blue image is displayed through the first sub-pixel 200a provided with the first color filter 201a in the liquid crystal display panel 20. The G light source 111c is continuously turned on.

Concurrently, during the ON duration (TG) of the one frame of image in the G light source 111c, the video signal (G1) associated with green is applied to the second sub-pixel 200b of the liquid crystal display panel 20. Thus, one screen of green image is displayed through the second sub-pixel 200b provided with the second color filter 201b in the liquid crystal display panel 20.

One frame of image is formed based on the display of the three color images, and a viewer recognizes a full-color image by combining the three colors. In this scheme, each pixel is made up of two sub-pixels. Thus, the number of sub-pixels can be reduced to ⅔ as compared with conventional liquid crystal display devices, and a response speed may be reduced to ⅔ as compared with the conventional field sequential driving scheme.

For example, while the conventional field sequential driving scheme requires a liquid crystal display panel capable of a high-speed response of about 1.5 ms or less, the liquid crystal display device according to the first embodiment allows a liquid crystal display panel to have a response speed of about 2.5 ms. Thus, for example, even a liquid crystal display panel using OCB mode liquid crystal can be driven. If a total number of sub-pixels is set at the same value as that of a conventional liquid crystal display panel, a liquid crystal display device with 1.5 times higher definition than ever before can be achieved. Alternatively, if a total number of unit pixels is set at the same value as that of a conventional liquid crystal display panel, an aperture ratio can be increased 1.5 times as compared with a conventional liquid crystal display panel to provide a significant advantageous effect to a reduction in power consumption of a backlight illuminator. In addition, a fabrication yield of the liquid crystal display panels can be improved and achieve a low-cost liquid crystal display device.

To cite one specific example, in an active matrix-type liquid crystal display device having sub-pixels in a total number, for example, of (800×3×600), a conventional configuration was capable of displaying only an image corresponding to a resolution of the SVGA standard (800×600). By contrast, in the liquid crystal display device according to the first embodiment, a total number of sub-pixels may be (800×1.5×600) even in the SVGA standard. This advantage is also effective in liquid crystal display devices conforming to other standards, as well as the SVGA standard.

In the liquid crystal display device according to the first embodiment, the laser sources 111 comprising the R light source 111a, the G light source 111c and the B light source 111b are used in the backlight illuminator 101. This makes it possible to provide excellent color purity at each wavelength, and significantly widen a displayable color reproducibility range as compared with conventional liquid crystal display devices, so as to achieve a liquid crystal display device capable of reproducing a sharper and more natural tone.

Although the first embodiment has been described based one example where the OCB mode liquid crystal layer 203 is provided in the liquid crystal display panel 20, the present invention is not limited to the specific example. For example, any other suitable liquid crystal having a drivable speed approximately equal to that of the OCB mode liquid crystal may also be used. Further, ferroelectric liquid crystal capable of being driven at a higher speed as compared with the OCB mode liquid crystal may be used.

In the liquid crystal display device according to the first embodiment, the backlight illuminator adapted to uniformly emit laser light from the first principal surface in a planar pattern is disposed on the side of the back surface of the liquid crystal display panel, so as to have a flat panel-type configuration. Thus, the liquid crystal display device can be used as a display device for personal computers and large-screen thin-type liquid crystal televisions.

In the first embodiment, although the first sub-pixel 200a and the second sub-pixel 200b are provided, respectively, with the first color filter 201a adapted to allow only R light and B light to pass therethrough and the second color filter 201b adapted to allow only G light to pass therethrough, and R light and B light are emitted to the first sub-pixel 200a during the duration of the one frame (Tf), in synchronization with the driving of the first sub-pixel 200a, the present invention is not limited thereto. For example, a first sub-pixel and a second sub-pixel may be provided, respectively, with a first color filter adapted to allow only R light and G light to pass therethrough and a second color filter adapted to allow only B light to pass therethrough, and R light and G light may be emitted to the first sub-pixel 200a during the duration of the one frame (Tf), in synchronization with the driving of the first sub-pixel 200a. Alternatively, a first sub-pixel and a second sub-pixel may be provided, respectively, with a first color filter adapted to allow only G light and B light to pass therethrough and a second color filter adapted to allow only R light to pass therethrough, and the light sources may be turned on based on the same driving scheme as that described above.

Although the first embodiment has been described based on one example where one frame of image is divided into two pieces, and two color lights are emitted alternately during every duration of the ½ frame, in conjunction with displaying corresponding ones of two color images, the present invention is not limited to the specific example. For example, one frame of image may be divided into n pieces (n: an integer of two or more), and two color lights may be placed in their ON state alternately during every duration of the 1/n frame, in conjunction with displaying corresponding ones of two color images, to obtain the same effect.

Although the first embodiment has been described based on one example where the green SHG-LD source adapted to be turned on under the CW operation is used as the G light source, the present invention is not limited to the specific example. For example, the green SHG-LD source may be driven by a pulse train, using a Q-switch, to generate a train of light pulses having a largely increased light intensity peak. The Q-switch is a technique of inserting a light modulator or the like into a laser resonator to rapidly increase a Q value of the laser resonator at a certain moment so as to initiate lasing and release energy previously accumulated in a laser medium, at once in the form of a light pulse. If the light pulse is formed as a train of light pulses, a green laser light can have an increased peak power and a stable output intensity. In case of forming a train of light pulses using the Q-switch, a stable output intensity can be obtained by generating a constant pulse train on a steady basis, although it is difficult to modulate the output intensity.

Although the first embodiment is illustrated as a configuration where the first sub-pixel 200a and the second sub-pixel 200b have the same area, the present invention is not limited to the specific configuration. In the first embodiment, R light and B light are placed in their ON state alternately during every duration of the ½ frame with respect to the one frame of image. Consequently, a quantity of each of the R and B lights per frame of image is reduced to about one-half as compared with the G light continuously placed in its ON state during the duration of the one frame of image. For this reason, an aperture ratio of the sub-pixel 201a adapted to allow the R and B lights to pass therethrough is set to be about two times greater than that of the sub-pixel adapted to allow the G light to pass therethrough, so as to eliminate the reduction in light quantity to achieve a light quantity substantially equal to that of the G light. Alternatively, an area of each of the sub-pixels may be changed in proportion to an average light quantity of a corresponding one of the R, B and G light sources. The sub-pixels each having an area changed in proportion to the average light quantity in the above manner make it possible to provide a liquid crystal display device capable of achieving higher image quality.

Although the first embodiment has been described based on one example where the backlight illuminator serving as a light source section comprises the laser sources adapted to emit R light, G light and B light, respectively, and the flat plate-shaped light-guiding plate adapted to introduce laser light sent from each of the laser sources, from the first edge surface, and emit the introduced light from the first principal surface, wherein the light-guiding plate is operable to guide the laser light entered from the first edge surface and emit the guided light from the first principal surface in a planar pattern, the present invention is not limited to the specific example. For example, the light-guiding section may be designed to guide the laser light entered into the transparent light-guiding portion of the light-guiding plate, while diffracting or reflecting the entered laser light toward the first principal surface. A hologram element or a semi-transparent mirror may be provided in the transparent light-guiding portion to partially diffract or partially reflect the entered laser light toward the first principal surface. This makes it possible to provide a liquid crystal display device capable of achieving high brightness and high image quality, in the same manner as that described above.

### Second Embodiment

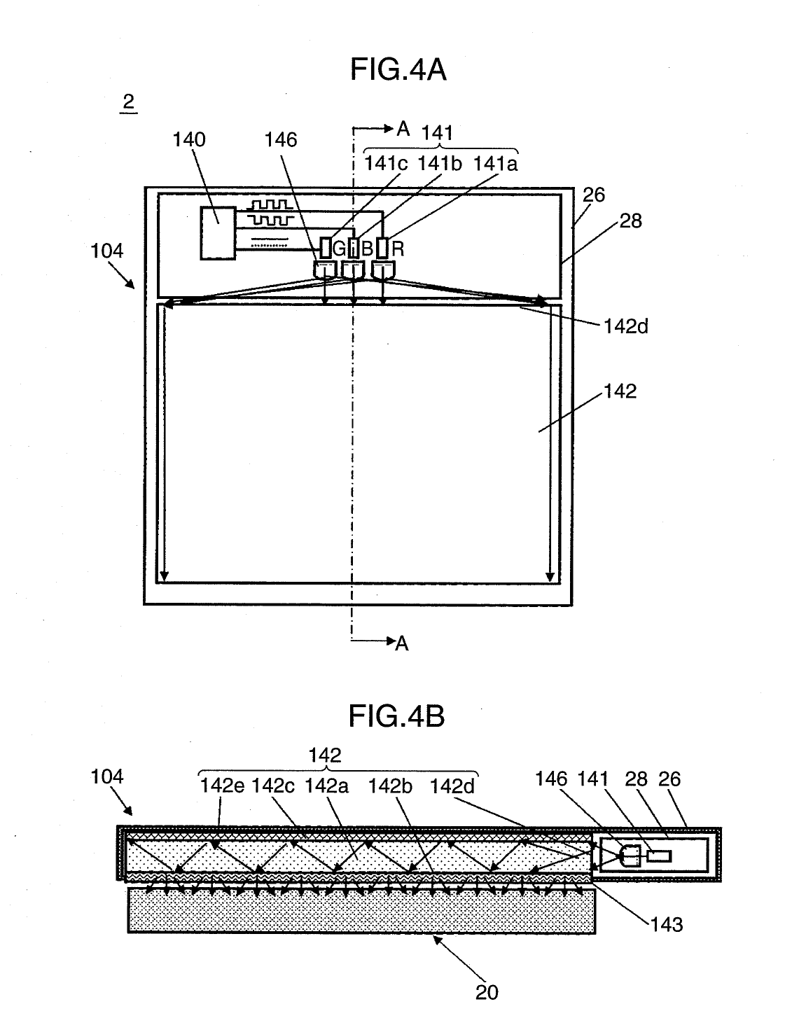

FIGS. 4A and 4B show a configuration of a liquid crystal display device 2 according to a second embodiment of the present invention, wherein FIG. 4A is a schematic top plan view showing an outline of the configuration of the liquid crystal display device 2, FIG. 4B is a schematic sectional view taken along the line A-A in FIG. 4A. The same element as that in FIGS. 1A and 1B is defined by a common code, and its description will be omitted on a case-by-case basis. In the illustration of the liquid crystal display device 2, respective surfaces of a housing 26 and a compartment 28 are cut away to show an internal configuration in an easily understandable manner. The liquid crystal display device 2 illustrated in FIGS. 4A and 4B is different from the liquid crystal display device 1 illustrated in FIGS. 1A to 2B, in that a light-emitting diode (LED) is used as a light source for use in a light source section. A configuration of a liquid crystal display panel 2 in the second embodiment and a driving strategy therefor are the same as those in the liquid crystal display device 1 according to the first embodiment.

As shown in FIGS. 4A and 4B, in the liquid crystal display device 2 according to the second embodiment, a backlight illuminator 104 serving as a light source section comprises a plurality of light-emitting diode source (hereinafter referred to as “LED source”) 141, and a flat plate-shaped light-guiding plate 142 adapted to introduce a light sent from each of the LED sources 141, from a first one 142d of opposite edge surfaces thereof, and, after guiding the introduced light through a transparent light-guiding portion 142a, uniformly emit the light from a first one 142b of opposite principal surfaces thereof in a planar pattern. Further, a reflection layer 142e formed in a dot pattern shape is provided on the other, second, principal surface 142c of the light-guiding plate 142 to facilitate light uniformity. Furthermore, a diffuser plate 143 is provided on the side of the first principal surface 142b of the light-guiding plate 142 to diffuse light. Although not illustrated, a prism lens sheet or the like may be provided to allow light to be emitted with more uniform in-plane brightness.

In the second embodiment, the LED sources 141 of the backlight illuminator 104 comprise an R-LED source 141a, a B-LED source 141b and a G-LED source 141c, which are adapted to generate R light, B light and G light, respectively. Each of the R-LED source 141a, the B-LED source 141b and the G-LED source 141c is adapted to be drivenly turned on by a voltage having a given driving waveform from an LED-driving circuit section 140, according to an after-mentioned driving strategy.

As one example of a technique of introducing R light, B light and G light from the R-LED source 141a, the B-LED source 141b and the G-LED source 141c, to the light-guiding plate 142, it is contemplated that a wavefront of each of R, B and G lights from the R-LED source 141a, the B-LED source 141b and the G-LED source 141c is widened by a corresponding one of three lenses 146, and then the R, B and G lights are introduced into the first edge surface 142d of the light-guiding plate 142. Although not illustrated, a plurality of sets each consisting of the R-LED source 141a, the B-LED source 141b and the G-LED source 141c may be arranged side-by-side to increase a light power and uniformly introduce the lights.

The liquid crystal display device 2 according to the second embodiment can perform the same image display as that in the liquid crystal display device 1 according to the first embodiment, by use of the liquid crystal display panel 20 and the same driving scheme as that described in connection with the liquid crystal display device 1 according to the first embodiment. Specifically, the backlight illuminator 104 is operable to alternately turn on the R-LED source 141a and the B-LED source 141b for R light and B light, while continuously turning on the G-LED source 141c during a duration of one frame, and emit lights generated by the sources toward the back surface of the liquid crystal display panel 20, in a planar pattern and with uniform brightness.

While a driving scheme will be described based on the timing chart in FIG. 3 showing the driving scheme (n=2), a basic concept thereof is the same as that in the liquid crystal display device 1 according to the first embodiment.

An image signal, e.g., R1, to be supplied to a first sub-pixel 200a of the liquid crystal display panel 20 by a drive control section 21 in FIG. 2A is a signal formed by compressing an original video signal input from the outside in association with red, in a direction of a time axis at a rate of one-half of one frame (Tf) (n=2). An image signal, e.g., G1, to be supplied to a second sub-pixel 200b of the liquid crystal display panel 20 by the drive control section 21 is an original video signal input from the outside in association with green. An image signal, e.g., B1, to be supplied to the first sub-pixel 200a of the liquid crystal display panel 20 by the drive control section 21 is a signal formed by compressing an original video signal input from the outside in association with blue, in the direction of the time axis at a rate of one-half of one frame (Tf) (n=2). That is, the drive control section 21 for the liquid crystal display panel 20 is operable to time-divide one frame (Tf) of image into two pieces (n=2), and apply respective image information about R and B to the first sub-pixel 200a, during every one of the ON durations TR, TB of the ½ frames, while applying image information about G to the second sub-pixel 200b, during a duration of the one frame (Tf) of image, i.e., during the duration TG.

Further, the backlight illuminator 101 serving as a light source section is operable to alternately turn on the R-LED source 141a and the B-LED source 141b in the LED sources 141, during every one of the ON durations TR, TB of one-halves of the one frame (Tf) of image (n=2), while continuously turning on the G-LED source 141c during the duration of the one frame (Tf) of image, i.e., during the ON duration (TG).

In this manner, during the ON duration (TR) of the ½ frame in the R-LED source 141a, the video signal (R1) associated with red and compressed to ½ is applied to the first sub-pixel 200a of the liquid crystal display panel 20 in synchronization with the ON duration (TR) by the drive control section 21. Thus, one screen of red image is displayed through the first sub-pixel 200a provided with the first color filter 201a in the liquid crystal display panel 20.

Then, during the ON duration (TB) of the subsequent ½ frame in the B-LED source 141b, the video signal (B1) associated with blue and compressed to ½ is applied to the first sub-pixel 200a of the liquid crystal display panel 20 in synchronization with the ON duration (TB). Thus, one screen of blue image is displayed through the first sub-pixel 200a provided with a first color filter 201a in the liquid crystal display panel 20.

Concurrently, during the ON duration (TG) of the one frame of image in the G-LED source 141c, the video signal (G1) associated with green is applied to the second sub-pixel 200b of the liquid crystal display panel 20. Thus, one screen of green image is displayed through the second sub-pixel 200b provided with a second color filter 201b in the liquid crystal display panel 20.

One frame of image is formed based on the display of the three color images, and a viewer recognizes a full-color image by combining the three colors. In this scheme, the number of sub-pixels can be reduced to ⅔ as compared with conventional liquid crystal display devices, and a response speed may be reduced to ⅔ as compared with the conventional field sequential driving scheme.

As above, the LED sources are used in the backlight illuminator, and the driving scheme is configured to perform display while switching only two of the three colors. This configuration makes it possible to significantly widen a displayable color reproducibility range so as to reproduce a full-color image with sharp and natural tone. In addition, the configuration facilitates enhancing a resolution and increasing an aperture ratio to provide significantly advantageous effects in enhancement in definition and reduction in cost of the liquid crystal display device.

The liquid crystal display device according to the second embodiment can be formed in a flat panel-type configuration. Thus, the liquid crystal display device can be used as a display device for personal computers and large-screen thin-type liquid crystal televisions.

Although the first and second embodiments have been described based on one example where the laser source or LED source is used as a light source of the light source section, the present invention is not limited to the specific example. An excitation luminescence light source using field emission or an organic or inorganic electroluminescent light source (EL) may be used. Further, a combination of two or more of the laser source, the LED source, the excitation luminescence light source using field emission may also be used. In this case, color purity at each wavelength is significantly improved as compared with a cold cathode fluorescent tube, so that a displayable color reproducibility range can be significantly widened to achieve a liquid crystal display device capable of reproducing a sharper and more natural tone.

### Third Embodiment

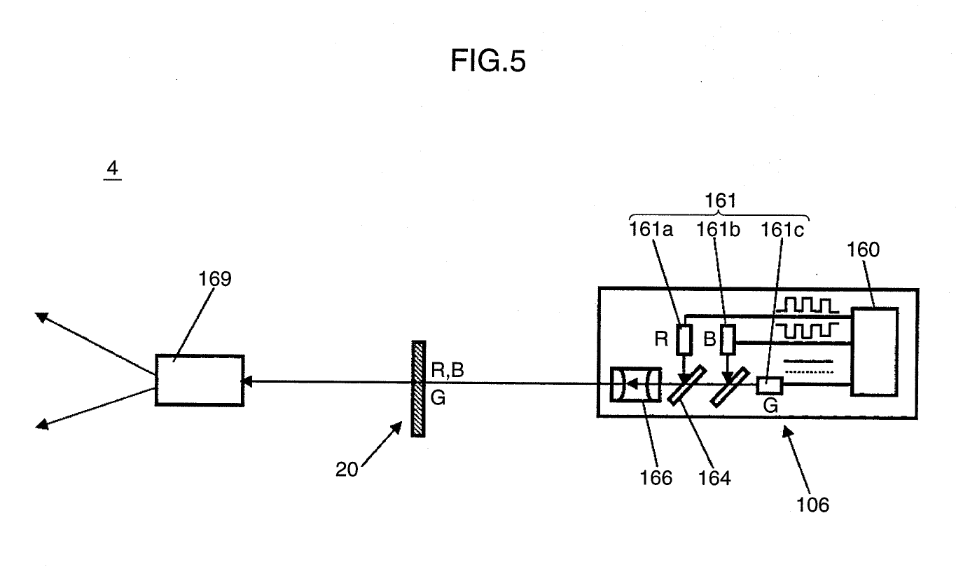

FIG. 5 is a conceptual sectional view showing a configuration of a liquid crystal display device 4 according to a third embodiment of the present invention. The same element as that in FIGS. 1A to 4B is defined by a common code, and its description will be omitted on a case-by-case basis. The liquid crystal display device 4 illustrated in FIG. 5 is different from the liquid crystal display device 1 according to the first embodiment and the liquid crystal display device 2 according to the second embodiment, in that the liquid crystal display device 4 has a projection-type configuration having a projection-type illuminator as the light source section, wherein parallel lights are emitted from the projection-type illuminator to a surface of a liquid crystal display panel, and transmitted lights are displayed on a screen. A configuration of a liquid crystal display panel 20 illustrated in FIG. 5 is the same as the configuration illustrated in FIGS. 2A and 2B. Thus, the following description will be made based on the codes shown in FIGS. 2A and 2B.

The projection-type liquid crystal display device 4 according to the third embodiment comprises one transmissive liquid crystal panel 20 serving as a light valve. In the third embodiment, a light source section 106 is a projection-type illuminator. Thus, the light source section will hereinafter be referred to as “light source section 106” or “projection-type illuminator 106”. This projection-type illuminator 106 is designed to, after turning on an R light-emitting source 161a and a B light-emitting source 161b alternately during a duration of one frame, while continuously turning on a G light-emitting source 161c during the duration of the one frame, to form R, B and G beam light, as with the backlight illuminator 101 used in the liquid crystal display device 1 according to the first embodiment, convert the R, B and G beam light into parallel lights through a lens system 166, and emit the parallel lights. A laser source or a light-emitting diode having a high light intensity may be used as a light-emitting source 161 of the light source section 106. A driving scheme for driving the R light-emitting source 161a, the B light-emitting source 161b and the G light-emitting source 161c by a light source-driving circuit section 160 is the same as that in the liquid crystal display device 1 according to the first embodiment.

In FIG. 5, a first sub-pixel 200a and a second sub-pixel 200b of a unit pixel 200 in the liquid crystal display panel 20 adapted to operate as an RGB light valve are provided with a first color filter 201a and a second color filter 201b, respectively. Specifically, in the liquid crystal display panel 20, the first color filter 201a provided in the first sub-pixel 200a is adapted to allow only any two (e.g., R and B lights) of R, G and B lights to pass therethrough. The second color filter 201b provided in the second sub-pixel 200b is adapted to allow only the remaining one light (e.g., G light) other than the two lights. The OCB mode liquid crystal layer 203 and the remaining components are the same as those of the liquid crystal panel 20 in the liquid crystal display device 1 according to the first embodiment.

The liquid crystal display panel 20 in the first embodiment has been described as a flat type which is a relatively large-size liquid crystal display panel for use in a personal computer or a thin-type television. The liquid crystal display panel 20 in the third embodiment is fabricated using the same components. However, a size thereof is typically about 1 to 2 inches, although it varies depending on a size of a display screen. Thus, a size of the unit pixel 200 is extremely small.

In the liquid crystal display device 4 according to the third embodiment, R light and B light in parallel lights emitted from the projection-type illuminator 106 are entered into the liquid crystal panel 20 in parallel while being placed in their ON state alternately during a duration of one frame, and optically modulated by the first sub-pixel 200a. Then, the optically modulated R and B lights are entered into a projection lens system 169. Further, G light is entered into the liquid crystal panel 20 in parallel in its ON state during the duration of the one frame, and optically modulated by the second sub-pixel 200b. Then, the optically modulated G light is entered into the projection lens system 169. The optically modulated R, G and B lights are enlarged and projected toward a front screen or rear screen (not shown) by the projection lens system 169.

While a driving scheme for the projection-type liquid crystal display device 4 according to the third embodiment will be described based on FIG. 3, a basic concept thereof is the same as that in the liquid crystal display device 1 according to the first embodiment.

An image signal, e.g., R1, to be supplied to the first sub-pixel 200a of the liquid crystal display panel 20 by the drive control section 21 is a signal formed by compressing an original video signal input from the outside in association with red, in a direction of a time axis at a rate of one-half of one frame (Tf) (n=2). An image signal, e.g., G1, to be supplied to the second sub-pixel 200b of the liquid crystal display panel 20 by the drive control section 21 is an original video signal input from the outside in association with green. An image signal, e.g., B1, to be supplied to the first sub-pixel 200a of the liquid crystal display panel 20 by the drive control section 21 is a signal formed by compressing an original video signal input from the outside in association with blue, in the direction of the time axis at a rate of one-half of one frame (Tf) (n=2). That is, the drive control section 21 for the liquid crystal display panel 20 is operable to time-divide one frame (Tf) of image into two pieces (n=2), and apply respective image information about R and B to the first sub-pixel 200a, during every one of the ON durations TR, TB of the ½ frames, while applying image information about G to the second sub-pixel 200b, during a duration of the one frame (Tf) of image, i.e., during the duration TG.

Further, the projection-type illuminator 106 serving as a light source section is operable to alternately turn on the R light-emitting source 161a and the B light-emitting source 161b in the light-emitting source 161, during every one of the ON durations TR, TB of one-halves of the one frame (Tf) of image (n=2), while continuously turning on the G light-emitting source 161c during the duration of the one frame (Tf) of image, i.e., during the ON duration (TG).

In this manner, during the ON duration (TR) of the ½ frame in the R light-emitting source 161a, the video signal (R1) associated with red and compressed to ½ is applied to the first sub-pixel 200a of the liquid crystal display panel 20 in synchronization with the ON duration (TR) by the drive control section 21. Thus, one screen of red image is displayed through the first sub-pixel 200a provided with the first color filter 201a in the liquid crystal display panel 20.

Then, during the ON duration (TB) of the subsequent ½ frame in the B light-emitting source 161b, the video signal (B1) associated with blue and compressed to ½ is applied to the first sub-pixel 200a of the liquid crystal display panel 20 in synchronization with the ON duration (TB). Thus, one screen of blue image is displayed through the first sub-pixel 200a provided with the first color filter 201a in the liquid crystal display panel 20.

Concurrently, during the ON duration (TG) of the one frame of image in the G light-emitting source 161c, the video signal (G1) associated with green is applied to the second sub-pixel 200b of the liquid crystal display panel 20. Thus, one screen of green image is displayed through the second sub-pixel 200b provided with the second color filter 201b in the liquid crystal display panel 20.

One frame of image is formed based on the display of the three color images, and enlargedly projected to a screen (not shown) provided in a frontward or rearward direction, by the projection lens system 169. A viewer recognizes a full-color image by combining the three colors. In this scheme, the number of sub-pixels can be reduced to ⅔ as compared with conventional liquid crystal display devices, and a response speed may be reduced to ⅔ as compared with the conventional field sequential driving scheme.

In the above manner, the liquid crystal display device 4 is provided as a front projection-type or rear projection-type configuration. This liquid crystal display device 4 makes it possible to facilitate enhancing a resolution and increasing an aperture ratio so as to achieve a larger screen and higher definition than ever before. In addition, the number of liquid crystal 1 panel can be limited to one, which is significantly effective in achieving an ultrasmall projector. A size required for achieving this liquid crystal display device 4 is 50 cc in a volume.

### Fourth Embodiment

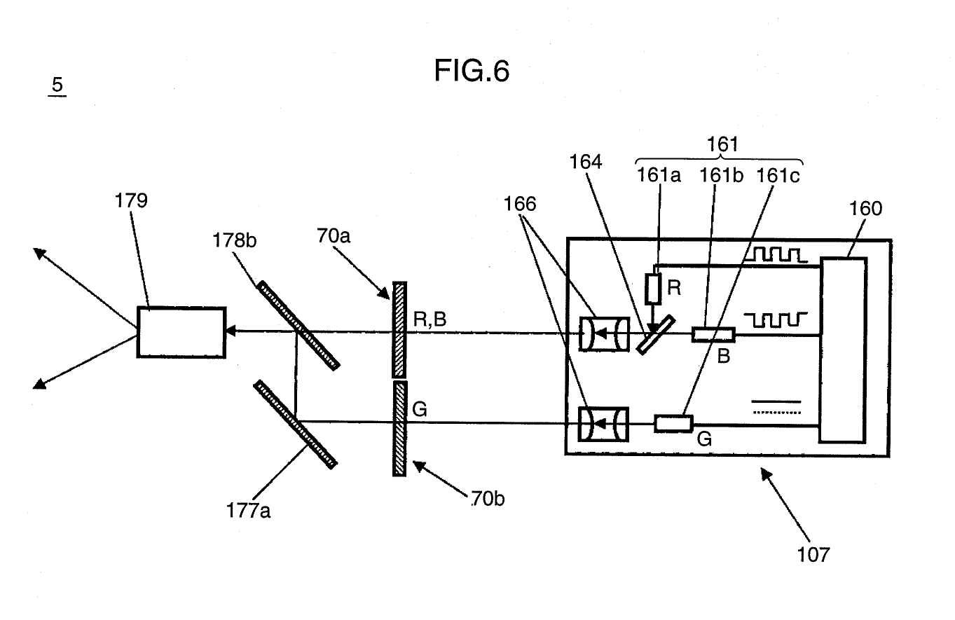

FIG. 6 is a conceptual sectional view showing a configuration of a liquid crystal display device 5 according to a fourth embodiment of the present invention. The same element as that in FIG. 5 is defined by a common code, and its description will be omitted on a case-by-case basis. The liquid crystal display device 5 illustrated in FIG. 6 is different from the liquid crystal display device 4 illustrated in FIG. 5, in that two liquid crystal display panels 70a, 70b are used, wherein each of the liquid crystal display panels 70a, 70b has the same unit pixel and sub-pixels, and no color filter is provided.

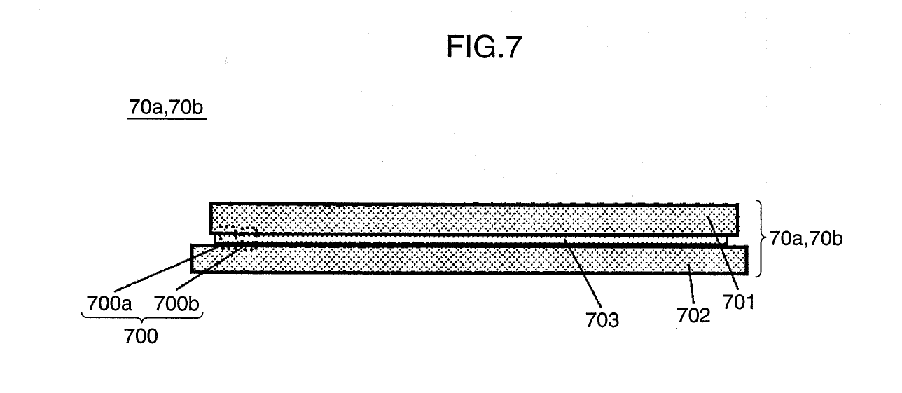

In the projection-type liquid crystal display device 5 illustrated in FIG. 6 according to the fourth embodiment, two transmissive liquid crystal panels 70a, 70b as shown in FIG. 7 are used as a light valve. FIG. 7 is a conceptual sectional view showing a configuration of the liquid crystal display panels 70a, 70b of the projection-type liquid crystal display device 5 according to the fourth embodiment. In the fourth embodiment, a light source section 107 is a projection-type illuminator. Thus, the light source section will hereinafter be referred to as “light source section 107” or “projection-type illuminator 107”.

In FIGS. 6 and 7, the liquid crystal display panel 70a serves as a light valve for R light and B light, and the liquid crystal display panel 70b serves as a light valve for G light. In the liquid crystal display device 5 according to the fourth embodiment, R light and B light in parallel lights emitted from the projection-type illuminator 107 are entered into the liquid crystal display panel 70a serving as a light valve, while being placed in their ON state alternately during a duration of one frame, and optically moderated. Then, after passing through a G light-reflectable dichroic mirror 178b, optically modulated R and B lights are entered into a projection lens system 179.

Concurrently, G light is entered into the liquid crystal display panel 70b serving as a light valve, while being continuously placed in it ON state during the duration of the one frame, and optically moderated. Then, optically modulated G light is reflected by a total reflection mirror 177a and the G light-reflectable dichroic mirror 178b, and multiplexed with the R light or B light. The R, B and G lights are arranged to be on the same light axis when they are entered into the projection lens system 179. The R, G and B lights are enlarged and projected to a front screen or rear screen (not shown) by the projection lens system 179. A viewer recognizes a full-color image by combining the three colors. In this scheme, the number of sub-pixels is the number of unit pixels so as to achieve a higher definition display, and a response speed may be reduced to ⅔ as compared with the conventional field sequential driving scheme.

As seen in FIG. 6, in the projection-type illuminator 107 of the liquid crystal display device 5 according to the fourth embodiment, the lens system 166 for converting lights from R light source 161a and B light source 161b into parallel lights, and the lens system 166 for converting light from G light source 161c into a parallel light, are formed to have the same characteristics and shape, and disposed separately.

As shown in FIG. 7, each of the liquid crystal panels 70a, 70b of the liquid crystal display device 5 according to the fourth embodiment is an active matrix-type high-speed response liquid crystal panel, such as an OCB mode liquid crystal display panel. In FIG. 7, some components, such as a driving TFT, a transparent electrode, an electrode wiring, a sealing portion and a polarizing plate, are omitted, for simplifying explanation.

For example, an OCB mode liquid crystal layer 703 is used in each of the liquid crystal panels 70a, 70b. A unit pixel 700 of the liquid crystal panel is made up of a first sub-pixel 700a and a second sub-pixel 700b formed between two transparent substrates 701, 702. In the liquid crystal panels 70a, 70b, no color filter is provided in the first sub-pixel 700a and the second sub-pixel 700b. Thus, the first sub-pixel 700a and the second sub-pixel 700b are indistinctive, and each of them has a function of a unit pixel. The OCB mode liquid crystal layer 703 and the remaining components are the same as those of the liquid crystal panel 20 in the liquid crystal display device 1 according to the first embodiment.

A driving scheme for the liquid crystal display device 5 according to the fourth embodiment will be described based on the timing chart illustrated in FIG. 3.

An image signal, e.g., R1, to be supplied to the first sub-pixel 700a and the second sub-pixel 700b of the liquid crystal display panel 70a by the drive control section (not shown) is a signal formed by compressing an original video signal input from the outside in association with red, in a direction of a time axis at a rate of one-half of one frame (Tf) (n=2). An image signal, e.g., G1, to be supplied to the first sub-pixel 700a and the second sub-pixel 700b of the liquid crystal display panel 70b by the drive control section is an original video signal input from the outside in association with green. An image signal, e.g., B1, to be supplied to the first sub-pixel 700a and the second sub-pixel 700b of the liquid crystal display panel 70a by the drive control section is a signal formed by compressing an original video signal input from the outside in association with blue, in the direction of the time axis at a rate of one-half of one frame (Tf) (n=2). That is, the drive control section for the liquid crystal display panel 70a is operable to time-divide one frame (Tf) of image into two pieces (n=2), and apply respective image information about R and B to the first sub-pixel 700a and the second sub-pixel 700b, during every one of the ON durations TR, TB of the ½ frames, while applying image information about G to the first sub-pixel 700a and the second sub-pixel 700b, during a duration of the one frame (Tf) of image, i.e., during the duration TG.

Further, the projection-type illuminator 107 serving as a light source section is operable to alternately turn on an R light-emitting source 161a and a B light-emitting source 161b in a light-emitting source 161, during every one of the ON durations TR, TB of one-halves of the one frame (Tf) of image (n=2), while continuously turning on a G light-emitting source 161c during the duration of the one frame (Tf) of image, i.e., during the ON duration (TG).

In this manner, during the ON duration (TR) of the ½ frame in the R light-emitting source 161a, the video signal (R1) associated with red and compressed to ½ is applied to the first sub-pixel 700a and the second sub-pixel 700b of the liquid crystal display panel 70a in synchronization with the ON duration (TR) by the drive control section. Thus, one screen of red image is displayed through the first sub-pixel 700a and the second sub-pixel 700b in the liquid crystal display panel 20.

Then, during the ON duration (TB) of the subsequent ½ frame in the B light-emitting source 161b, the video signal (B1) associated with blue and compressed to ½ is applied to the first sub-pixel 700a and the second sub-pixel 700b of the liquid crystal display panel 70a in synchronization with the ON duration (TB). Thus, one screen of blue image is displayed through the first sub-pixel 700a and the second sub-pixel 700b in the liquid crystal display panel 70a.

Concurrently, during the ON duration (TG) of the one frame of image in the G light-emitting source 161c, the video signal (G1) associated with green is applied to the first second sub-pixel 700a and the second sub-pixel 700b of the liquid crystal display panel 70b. Thus, one screen of green image is displayed through and the first sub-pixel 700a and the second sub-pixel 700b in the liquid crystal display panel 70b.

One frame of image is formed based on the display of the three color images, and enlargedly projected to a screen (not shown) provided in a frontward or rearward direction, by the projection lens system 179. A viewer recognizes a full-color image by combining the three colors. In this scheme, the number of sub-pixels can be reduced to ⅔ as compared with conventional liquid crystal display devices, and a response speed may be reduced to ⅔ as compared with the conventional field sequential driving scheme.

In the above manner, the liquid crystal display device 5 is provided as a front projection-type or rear projection-type configuration. This liquid crystal display device 5 makes it possible to facilitate enhancing a resolution and increasing an aperture ratio so as to achieve a larger screen and higher definition than ever before.

Further, as compared with a conventional projection-type liquid crystal display device using total three liquid crystal display panels provided, respectively, for R color, G color and B color, the number of liquid crystal display panels can be reduced by one to reduce a cost and improve a resolution.

The fourth embodiment has been described based on one example where the liquid crystal display panel is a transmissive type. Alternatively, a reflective liquid crystal display panel may be used as a light valve.

Although the fourth embodiment has been described based on one example where an optical system has a dichroic minor separately provided therein, the present invention is not limited to the specific example. For example, an optical system using a three-color synthesis dichroic prism may be designed and arranged. In this optical system, the same effect can be obtained while facilitating a reducing in size.

Although the first to fourth embodiments have been described based on one example where two of three colors are switched therebetween during a duration of one frame, the present invention is not limited to the specific example. For example, one frame may be divided into a plurality of sub-frames, wherein two of three colors are switched therebetween during respective durations of the sub-frames. This makes it possible to suppress the flicker phenomenon which is one disadvantage of the field sequential driving scheme.

Although the first to fourth embodiments have been described based on one example where an image associated with the remaining one color is displayed by continuously turning on the light source for the remaining one color during the duration of the one frame of image, in conjunction with displaying an image associated with the remaining one color light, the present invention is not limited to the specific example. For example, an image signal associated with the remaining one color, e.g., G, may also be compressed to ½ (n=2), and repeatedly applied to the liquid crystal display panel during the duration of the one frame while turning on the light source of G two times (n=2) in conjunction with applying the image signal.

In each of the first to fourth embodiments, R, G and B lights may be placed in their OFF state between one frame and the next frame to insert a black display image. This makes it possible to obtain a sharp and clear image.

While the first to fourth embodiments have been described based on one example where an OCB mode liquid crystal display panel is used as the liquid crystal display panel, a ferroelectric liquid crystal panel having a higher response speed may be used. In this case, the liquid crystal display panel is effective as a reflective type, instead of a transmissive type. Specifically, a polarization of R, G and B lights entered after passing through a polarizing prism is rotated by 90 degrees through the ferroelectric liquid crystal panel. Then, the lights are directed to pass through the polarizing prism again, and reflected in another direction. In the reflective type, any other suitable liquid crystal other than ferroelectric liquid crystal may be used. The reflective type is suitable for an ultrasmall liquid crystal display panel.

### Fifth Embodiment

A fifth embodiment of the present invention will be described below. In the first to fourth embodiment, each pixel is made up of two sub-pixels, wherein one of the sub-pixels and the other sub-pixel are associated with two of red, blue and green, and the remaining one color, respectively, and an image is displayed while switching between the two colors in a time-division manner. In the fifth embodiment, sub-pixels corresponding to three colors are provided in a conventional manner, and a fluorescent material is arranged in a part of the sub-pixels in addition to a color filter. For example, a red LD source has difficulty in obtaining adequate output due to poor temperature characteristics. In this case, an output of red light can be stabilized by increasing an output of SHG green laser light based on the above configuration, and exciting red using an excess part of an output of the green light.

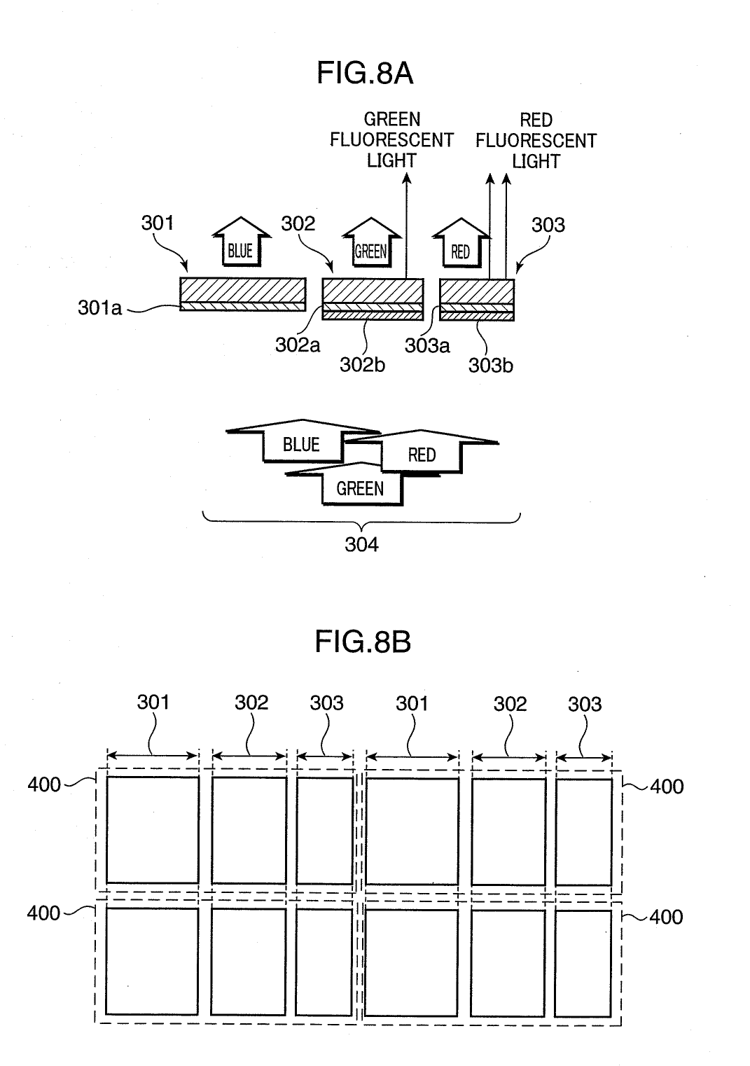

FIG. 8A shows respective configurations of pixels of a liquid crystal panel of a liquid crystal display device according to the fifth embodiment. Each pixel of the liquid crystal panel used in the fifth embodiment comprises three sub-pixels 301, 302, 303. The sub-pixels 301, 302, 303 have a blue color filter 301a, a green color filter 302a and a red color filter 303a, respectively. In the sub-pixels of the liquid crystal panel in the fifth embodiment, the green-displaying sub-pixel 302 further includes a fluorescent material layer 302b, and the red-displaying sub-pixel 303 further includes a fluorescent material layer 303b.

In FIG. 8A, three color laser lights 304 consisting of blue laser, red laser and green laser are entered into the blue-displaying sub-pixel 301, the green-displaying sub-pixel 302 and the red-displaying sub-pixel 303, respectively. The color filters 301a, 302a, 303a are attached to the sub-pixels 301, 302, 303, respectively, as mentioned above. In the blue-displaying sub-pixel 301, green laser and red laser in the laser lights 304 is cut by the color filter 301a, in a conventional manner. Differently, the green-displaying sub-pixel 302 and the red-displaying sub-pixel 303 are provided with the fluorescent material layer 302a and the fluorescent material layer 303b, respectively. This structure will be more specifically described below.

The fluorescent material layer 302a of the green-displaying sub-pixel 302 is prepared to contain a fluorescent material capable of absorbing blue and generating green, and attached to the color filter 302a on the side of the laser lights 304. The fluorescent material layer 302a has a function of allowing blue leaser light which otherwise be generally blocked by the color filter 302a and discarded, to be converted into green and reused as green light fluorescence. Thus, the converted green light is added to transmitted green laser light. In the same manner, the fluorescent material layer 302b of the red-displaying sub-pixel 303 is attached to the cut filter 303a on the side of the laser lights 304. The fluorescent material layer 302b has a property of absorbing blue and green, and generating red fluorescence.

The fluorescent material layer used in the fifth embodiment has a blue-to-green conversion efficiency of 70%, a blue-to-red conversion efficiency of 50%, and a green-to-red conversion efficiency of 70%.

FIG. 8B is a top plan view showing an arrangement of the four pixels in FIG. 8A. Each of the three sub-pixels 301, 302, 303 of each of the pixels 400 has a different opening area. As to an area ratio, given that the red-displaying sub-pixel 303 is “1”, the green-displaying sub-pixel 302 is set to be “1.7”, and the blue-displaying sub-pixel 301 is set to be “2.2”. This achieves an adequate white balance of a video when it is output from the liquid crystal panel.

The fluorescent material of each of the fluorescent material layers 302a, 303b will be supplementarily described below. In response to blue laser excitation, a Ce-based material can generate green light, and a Eu-based material can generate red light. The Eu-based material can generate red light in response to green laser excitation. A Pr-based material can exhibit strong light absorption in excitation at 450 nm and generate red light with high efficiency. The use of laser makes it possible to use a fluorescent material which otherwise cannot be used due to a steep excitation peak although it has high efficiency. The fluorescent material is not limited to the above materials.

In the fifth embodiment, light utilization efficiency can be drastically improved by using a laser-excitable fluorescent material. The fluorescent material layer provided on an upstream side relative to the color filter can perform the color conversion, and additionally cut an excess part of excitation light and fluorescence having an unwanted wavelength.

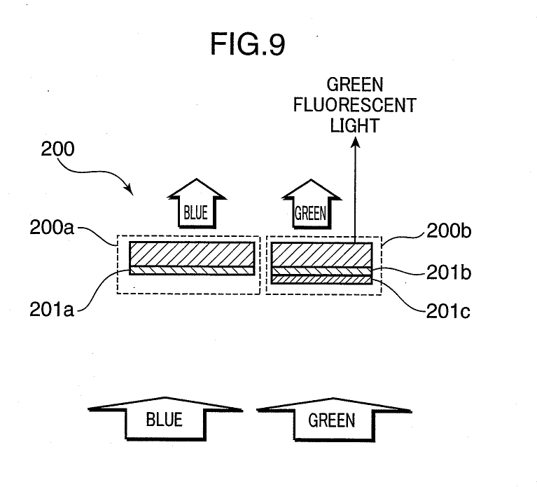

The fifth embodiment may be applied to the first embodiment. Specifically, when the second sub-pixel 200b in FIG. 2B is a blue-displaying sub-pixel, a fluorescent material layer 201c containing a fluorescent material capable of absorbing blue and generating green may be attached to the color filter 201b capable of blocking red and blue as shown in FIG. 9, to utilize green fluorescence converted from blue, during the ON duration TB of the blue light source in FIG. 3. Further, during the ON duration TA of the red light source in FIG. 3, red laser light is blocked by the color filter 201b, in the same manner as that in the first embodiment.

Each of the liquid crystal display devices according to the first to fifth embodiments is designed to switch between only two of three colors. Thus, as compared with the conventional field sequential driving scheme, a response speed required for a liquid crystal panel can be reduced, so that, for example an OCB mode liquid crystal display panel can be used. In addition, a resolution or aperture ratio can be more improved than ever before to provide significant effects of being able to achieve higher definition or lower power consumption and facilitate a reduction in cost of a liquid crystal display panel.

### Sixth Embodiment

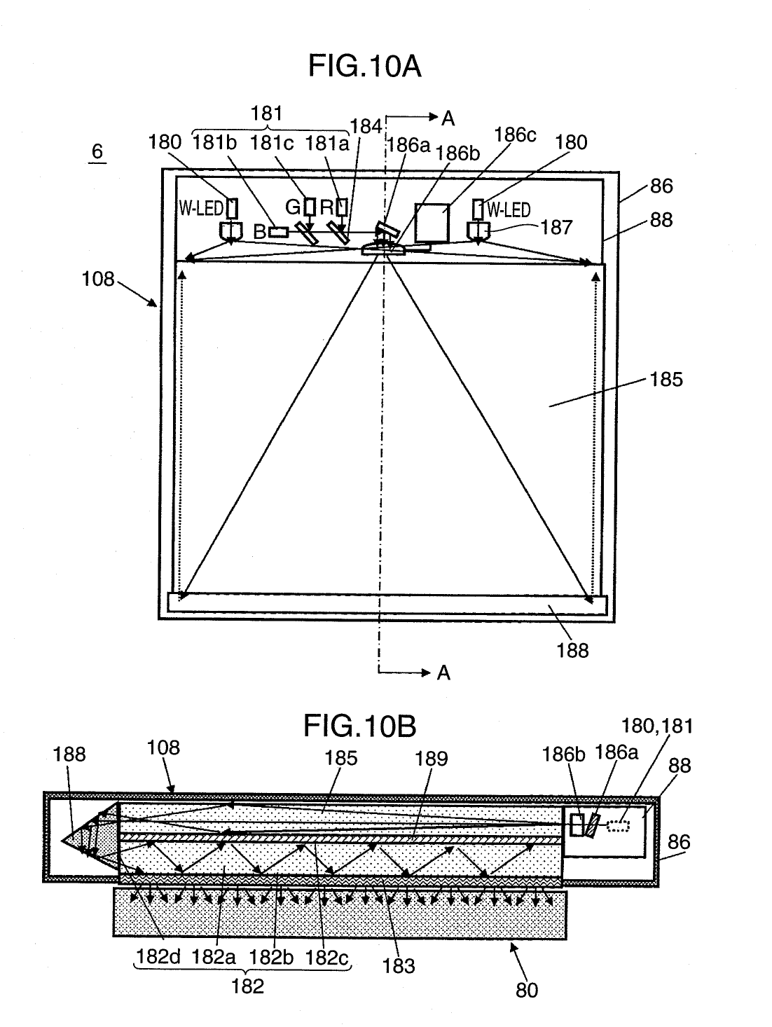

FIGS. 10A and 10B show a configuration of a liquid crystal display device 6 according to a sixth embodiment of the present invention, wherein FIG. 10A is a schematic top plan view showing the configuration of the liquid crystal display device 6, and FIG. 10B is a schematic sectional view taken along the line A-A in FIG. 10A. In the illustration of the liquid crystal display device 6, respective surfaces of a housing 86 and a compartment 88 for receiving therein a light source are cut away to show an internal configuration in an easily understandable manner.

The liquid crystal display device 6 according to the sixth embodiment comprises a liquid crystal display panel 80, and a backlight illuminator 108 adapted to illuminate the crystal display panel 80 from the side of a back surface thereof. The backlight illuminator 108 includes a laser source 181 for generating at least R light, G light and B light, and a white light source 180. The backlight illuminator 108 is adapted to emit laser lights generated by the laser source 181 and white light generated by the white light source 180, from a first one of opposite principal surface 182b of a flat plate-shaped light-guiding plate 182, so as to illuminate the crystal display panel 80. The backlight illuminator 108 serves as a light source section.

As shown in FIGS. 10A and 10B, in the liquid crystal display device 6, the backlight illuminator 108 including as a light source the laser source 181 for at least R, G and B lights, and the white light source 180, is disposed on the back surface of the crystal display panel 80 adapted to apply a voltage at least to liquid crystal thereof to display an image thereon.

In the sixth embodiment, the light-guiding plate 182 of the backlight illuminator 108 is adapted to introduce laser light sent from the laser source 181, from a first one 182d of opposite edge surfaces thereof, and emit the laser light from the first principal surface 182b in a planar pattern, while introducing white light sent from the white light source 180, from the first edge surface 182d, and emit the white light from the first principal surface 182b in a planar pattern.

Further, a diffuser plate 183 is provided on the side of the first principal surface 182b of the light-guiding plate 182 to diffuse light. In the sixth embodiment, a reflection layer 189 formed, for example, with a micro-dot pattern, is provided on the other, second, principal surface 182c of the light-guiding plate 182 to uniformly diffuse and reflect the entered laser light to direct the reflected laser light to the first principal surface 182b.

The laser source 181 has at least an R light source 181a, a G light source 181c and a B light source 181b adapted to generate R light, G light and B light, respectively. Among these laser sources, the G light source 181c may be SHG (Second Harmonic Generation)-semiconductor laser source. In the above laser source 181, each of the R light source 181a, a G light source 181c and a B light source 181b is turned on by a laser source-driving circuit section (not shown).

A light-emitting diode may be used as white light source 180. For example, a blue light-emitting diode may be used in such a manner that blue light generate by the blue light-emitting diode is converted into white light by a fluorescent material. In this case, white light may be generated by applying or attaching onto a blue light-emitting diode a fluorescent material capable of generating yellow fluorescence. The fluorescent material may be applied or attached to the blue light-emitting diode at a position to be exposed to blue light generated by the blue light-emitting diode. Alternatively, a fluorescent material may be mixed with a transparent resin to form a lens, and the lens may be attached to a top of a blue light-emitting diode to additionally serve as a lens. Alternatively, white light may be generated by exciting a fluorescent material using a light-emitting diode adapted to generate ultraviolet light.

In place of the light-emitting diode adapted to generate white light, a field emission electron excitation luminescence light source or an electroluminescence adapted to generate white light may be used as the white light source 180. When the electroluminescence is used, generated light may also be converted into white light by a fluorescent material. The white light source 180 is turned on by a white light-driving circuit section (not shown).

As one example of a technique of introducing laser light sent from the laser source 181, to the first edge surface of the light-guiding plate 182, laser lights sent from the R light source 181a, the G light source 181c and the B light source 181b are multiplexed together by a dichroic minor 184. The multiplexed lights are directed to pass through a reflection mirror 186a, and a beam plane of the lights is widened by a cylindrical lens 186b. The widened lights are entered into the first edge surface 182d of the light-guiding plate 182. The cylindrical lens 186b may be reciprocatingly moved by a lens-driving circuit section 186c to scan the widened lights.

In the backlight illuminator 108, a light path-changing section 188 is provided to come into contact with the first edge surface 182d of the light-guiding plate 182, and change light paths of the laser lights and white light in such a manner as to introduce the laser lights and white light to the first edge surface 182d of the light-guiding plate 182. Further, an auxiliary light-guiding plate 185 is provided in parallel relation to the light-guiding plate 182, to guide the lights from the laser source 181 and the white light source 180.

As one example of a technique of introducing white light sent from the white light source 180, to the first edge surface 182d of the light-guiding plate 182, white lights from an array of the white light sources 180 are widened by corresponding lenses 187, and the widened lights are entered into the first edge surface 182d through the auxiliary light-guiding plate 185 and the light path-changing section 188.

Thus, the backlight illuminator 108 used in the liquid crystal display device 6 according to the sixth embodiment can be formed in a thin configuration adapted to introduce R, G and B lights generated from the laser source 181 and white light generated from the white source 180, from the first edge surface 182d of the light-guiding plate 182, and emit the introduced lights from the first principal surface 186b in a planar pattern.

The liquid crystal display panel 80 is a transmissive type or semi-transmissive type, e.g., a TFT active matrix-type liquid crystal display panel having a pair of polarizing plates (not shown). Although not illustrated, a display region is provided with a large number of pixels each comprises at least a red pixel portion (R sub-pixel), a green pixel portion (G sub-pixel) and a blue pixel portion (B sub-pixel), and these are driven by TFTs. For example, TN mode liquid crystal layer or homeotropic mode liquid crystal layer is provided between two transparent substrates, in such a manner as to be oriented in a given direction. Each of the TFTs for driving the liquid crystal layer is formed in one of the two transparent substrates. A conventionally used configuration may be used as the liquid crystal display panel 80, and the R sub-pixel, the G sub-pixel, the B sub-pixel, TFTs and the liquid crystal layer are not illustrated. Their further description will be omitted.

In a normal full-color image display operation, the backlight illuminator 108 is operable to generate R light, G light and B light by the laser source 181 comprising at least the R light source 181a, the G light source 181c and the B light source 181b. Thus, the liquid crystal display panel 80 can display a clear full-color image with a wide color reproduction range. In an operation of displaying a white image, R, G and B lights are generated by the laser source 181 comprising the R light source 181a, the G light source 181c and the B light source 181b, and mixed together to display a white color image. When it is required to emphasize a white image with higher brightness in the image display operation, the white light source 180 is additionally turned on to further increase a white color intensity in the image display operation of the liquid crystal display device 6.

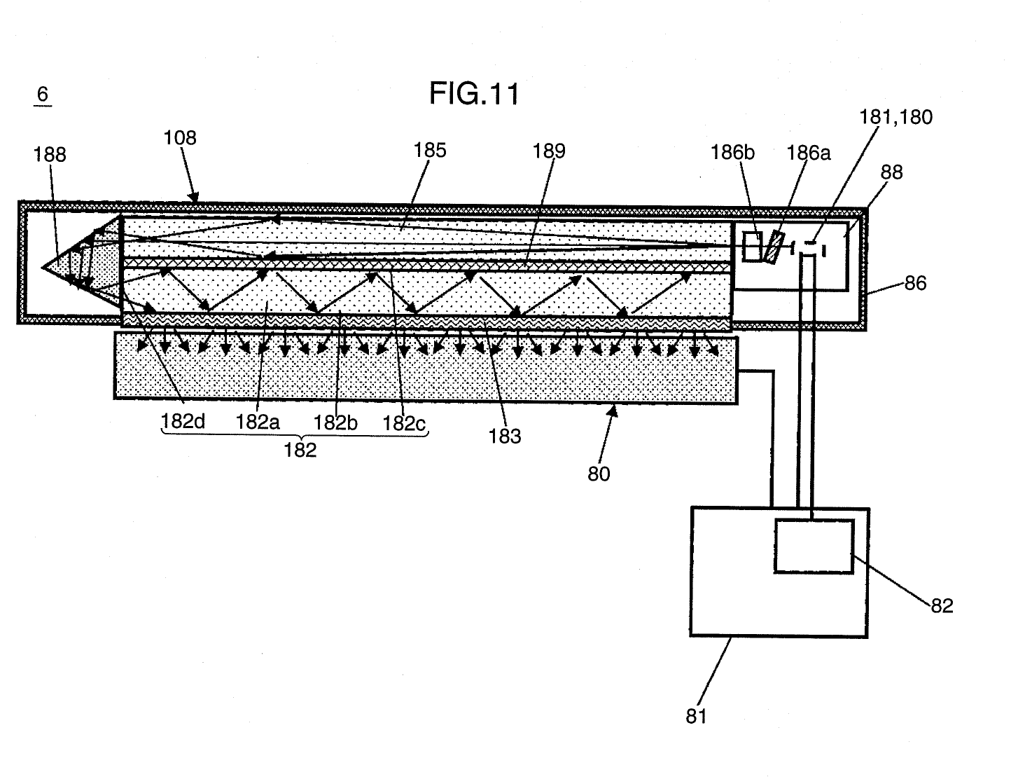

FIG. 11 is a schematic sectional view showing one example of a configuration for driving the backlight illuminator 108 to turn on the white light source 180 in an image display operation instructed to emphasize white. As shown in FIG. 11, a drive control section 81 for driving the liquid crystal display panel 80 is additionally provided with a brightness recognition circuit 82 adapted to recognize a brightness of an image to be display. In an image display operation instructed to emphasize white according to the brightness recognition circuit 82, the backlight illuminator 108 is driven to turn on the white light source 180. For example, in the image display operation instructed to emphasize white, the brightness recognition circuit 82 is operable to compare respective values of R, G and B signal voltages input thereinto or a ratio between the voltages with a predetermined value set therein, and, when each of the values or the ratio becomes greater or less than the predetermined value, recognize the fact. Then, the brightness recognition circuit 82 is operable to sent an instruction voltage signal for instructing to turn on the white light source, to a white light source-driving circuit section (not shown) of the backlight illuminator 108, so as to turn on the white light source 180.

As one example of an operation of switching between ON/OFF of the white light source 108 by the brightness recognition circuit 82, the white light source 180 may be turned on when the brightness recognition circuit 82 determines that a ratio of a white area in an image to be displayed on the liquid crystal display panel 80, to a total area of the image, becomes equal to or greater than a given value. For example, in cases where the liquid crystal display device is used as a television monitor, while a screen is required to have a significantly high brightness during a usual TV program, such as news or drama, there are many dark scenes in movie or the like. In this case, the brightness recognition circuit 82 is operable, in response to a bright screen requiring high brightness, to turn on the white light source 180, and, in response to an image requiring low brightness to turn off the white light source 180. More specifically, the white light source 180 may be turned on during a usual program, such as news, drama or variety, and only the laser source 181 may be turned on while turning off the white light source 180, during a program including many dark scenes, such as movie.

Although the above switching operation is configured to turn on/off the white light source 180 according to need, the sixth embodiment is not limited to this switching operation. For example, the white light source 180 may be continuously turned on at a constant output intensity, wherein an output intensity of the white light source 180 relative to that of the laser source 181 is increased during a bright scene, and the relative output intensity of the white light source 180 is reduced during a dark scene. This configuration can provide the same effect as that described above.

In the above configuration, the laser source 181 makes it possible to widen a color reproduction range, and the white light source 180 makes it possible to emphasize a white screen image during an image display operation instructed to emphasize the white screen image, so that a liquid crystal display device 6 capable of achieving higher definition and more natural image quality can be achieved.

In the liquid crystal display device 6 according to the sixth embodiment, laser light and white light can be simultaneously emitted from the first principal surface 182b of the light-guiding plate 182, so as to widen a color reproduction range while displaying an image with high quality, and emphasize white during display of a white screen image. This makes it possible to provide a flat panel-type small and thin liquid crystal display device capable of achieving high image quality.

Further, in the image display operation instructed to emphasize white, the brightness recognition circuit 82 is operable to recognize brightness of an image to be displayed, and drive the backlight illuminator 108 so as to turn on the white light source 180. Thus, in the image display operation instructed to emphasize white, the image can be displayed while automatically increasing brightness of white in a natural manner.

The white light source 180 is not limited to a light-emitting diode, but may be at least one selected from the group consisting of a light-emitting diode, a fluorescent display tube, a field emission excitation luminescence light source and excitation an electroluminescence each of which is adapted to generate white light. This type of white light source can suppress a fluctuation in white balance when a white screen image is displayed, and allows a natural white image to be displayed. In case of the light-emitting diode adapted to generate white light, white light to be generated is a color mixture of yellow of a yellow fluorescent material and blue of a blue light-emitting diode. This provides a light source capable of more effectively suppressing the fluctuation in white balance.

### Seventh Embodiment

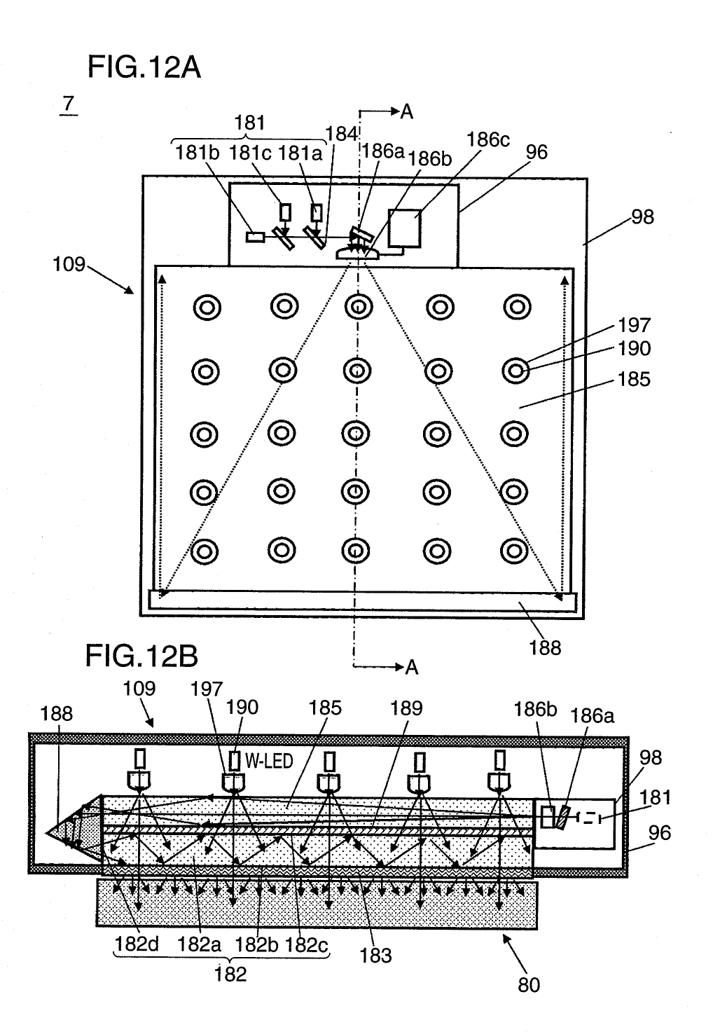

FIGS. 12A and 12B show a configuration of a liquid crystal display device 7 according to a seventh embodiment of the present invention, wherein FIG. 12A is a schematic top plan view showing the configuration of the liquid crystal display device 7, and FIG. 12B is a schematic sectional view taken along the line A-A in FIG. 12A. The same element as that in FIGS. 10A and 10B is defined by a common code, and its description will be omitted on a case-by-case basis. In the illustration of the liquid crystal display device 7, respective surfaces of a housing 96 and a compartment 98 for receiving therein a light source are cut away to show an internal configuration in an easily understandable manner. The liquid crystal display device 7 illustrated in FIGS. 12A and 12B is different from the liquid crystal display device 6 illustrated in FIGS. 10A and 10B, in that the liquid crystal display device 7 is designed to directly introduce white light into a liquid crystal display panel 80, from the side of the second principal surface 182c of the light-guiding plate 182 without passing through the auxiliary light-guiding plate 185 and the light path-changing section 188.

As shown in FIGS. 12A and 12B, a backlight illuminator 109 serving as a light source section is adapted to introduce R light, G light and B light sent from a laser source 181, from a first one 182d of opposite edge surfaces of a light-guiding plate 182 through an auxiliary light-guiding plate 185 and a light path-changing section 188, and emit the R, G and B lights from a first one 182b of opposite principal surfaces thereof, in the same manner as that in FIGS. 10A and 10B.

Differently, white light from a white light source 190 is introduced from the side of the other, second, principal surface 182c of the light-guiding plate 182, and emitted from the first principal surface 182b in a planar pattern. For this reason, the backlight illuminator 109 is configured such that a plurality of the white light sources 190 are arranged side by side in a line on the side of the second principal surface 182c of the light-guiding plate 182. Further, white lights from the white light sources 190 are widened by a lens 197, and then entered into the second principal surface 182c of the light-guiding plate 182. Thus, white lights entered into the second principal surface 182c of the light-guiding plate 182 at a right angle are transmitted through the light-guiding plate 182, whereas R, G and B lights from the laser source 181 are reflected by the principal surface 182c.

According to the above configuration, the backlight illuminator 109 used in the liquid crystal display device 7 according to the seventh embodiment is adapted to introduce R, G and B lights sent from the laser source 181, from the first edge surface 182d of the light-guiding plate 182, while introducing white lights sent from the white light sources 190, from the side of the second principal surface 182c of the light-guiding plate 182. Thus, R, G and B lights and white lights can be emitted from the first principal surface 182b in a planar pattern with a uniform brightness distribution. That is, in the liquid crystal display device 7 according to the seventh embodiment, white lights sent from the white light sources 190 are transmitted through the light-guiding plate to directly reach the liquid crystal panel 80. Thus, white lights from the white light sources 190 can be uniformly emitted to the liquid crystal panel 80 by arranging the white light sources 190 in such a manner that an in-plane distribution relative to a display screen of the liquid crystal panel 80 becomes uniform.

In a usual full-color image display operation, the backlight illuminator 109 is operable to place R, G and B lights in their ON state by the laser source 181 comprising the R light source 181a, the G light source 181c and the B light source 182b, to illuminate the liquid crystal panel 80 from a back surface thereof so as to allow the liquid crystal panel 80 to display a full-color image. Further, when white is emphasized in the image display operation, the backlight illuminator 109 is operable to turn on the white light sources 190 so as to allow a white image in the liquid crystal display device 7 to be more brightly displayed. Alternatively, white light sources 190 may be weakly turned on in the usual full-color image display operation, and strongly turned on when white is emphasized in the image display operation.

As described above, in the liquid crystal display device 7 according to the seventh embodiment, a white-emphasized screen image can be displayed with enhanced uniformity and higher brightness by introducing white lights of the white light sources 190, directly from the side of the second principal surface 182c of the light-guiding plate 182.

### Eighth Embodiment

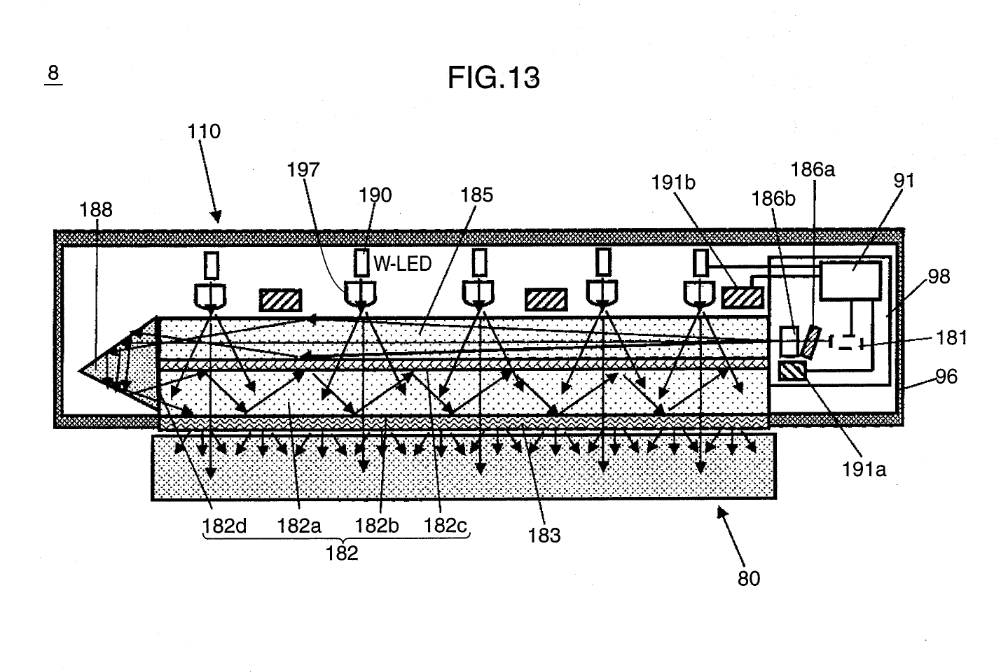

FIG. 13 is a schematic sectional view showing a configuration of a liquid crystal display device 8 according to an eighth embodiment of the present invention. The same element as that in FIGS. 10A, 10B, 12A and 12B is defined by a common code, and its description will be omitted on a case-by-case basis. The liquid crystal display device 8 illustrated in FIG. 13 is different from the liquid crystal display device 7 illustrated in FIGS. 12A and 12B, in that the liquid crystal display device 8 further includes a first light detector 191a adapted to detect respective light intensities of R light, G light and B light sent from a laser source 181, a second light detector 191b adapted to detect a light intensity of white light sent from a white light source 190, and a correction circuit 91 adapted, based on detection data from the first light detector 191a and the second light detector 191b during an image display operation, to correct the respective light intensities. That is, in the liquid crystal display device 8 according to the eighth embodiment, the first light detector 191a and the second light detector 191b are provided as a light detector.

As shown in FIG. 13, a backlight illuminator 110 is adapted to introduce R light, G light and B light sent from a laser source 181, from a first one 182d of opposite edge surfaces of a light-guiding plate 182 through an auxiliary light-guiding plate 185 and a light path-changing section 188, and emit the R, G and B lights from a first one 182b of opposite principal surfaces thereof, in the same manner as that in the liquid crystal display device 7 according to the seventh embodiment. Further, a plurality of white light sources 190 are arranged side by side in a line on the side of the other, second, principal surface 182c of the light-guiding plate 182, in the same manner as that in FIG. 12B. White lights from the white light sources 190 are widened by a lens 197, and then entered into the second principal surface 182c of the light-guiding plate 182.

The backlight illuminator 110 in the eighth embodiment includes a first light detector 191a composed of a photodiode, a phototransistor or the like, and adapted to detect respective light intensities of laser lights, i.e., R light, G light and B light, sent from the laser source 181, and a second light detector 191b composed of a photodiode, a phototransistor or the like, and adapted to detect a light intensity of white light sent from each of the white light sources 190. The backlight illuminator 110 also includes a correction circuit 91 adapted, based on detection data from the first light detector 191a and the second light detector 191b during an image display operation, to correct the respective light intensities of the laser lights and the white light.

The laser light-detecting first light detector 191a is installed at a position where laser light is leaking or radiated or reflected. Alternatively, the first light detector 191a may be installed in the laser source 181 itself, e.g., a light waveguide portion (not shown). The white light-detecting second light detector 191b is installed at a position where light from the white light source 190 leaks, or the light is reflected or emitted.

In the eighth embodiment, R light, G light and B light sent from the laser source 181 are emitted to the liquid crystal display panel 80 through the light-guiding plate 182, and white light sent from each of the white light sources 190 is directly emitted to the liquid crystal display panel 80, as with the seventh embodiment. Thus, the detection of intensives of the laser lights from the laser source 181, and the detection of an intensity of white light from each of the white light sources 190, can be performed at different positions, respectively. Specifically, the first light detector 191a is disposed to detect laser light leaking from the other, second, edge surface opposite to the first edge surface 182d of the light-guiding plate 182, so as to detect respective intensives of the laser lights from the laser source 181. The second detector 191b is disposed in adjacent relation to each of the white light sources 190 so as to detect an intensity of white light from each of the white light sources 190. Thus, the respective intensities of laser lights and white light can be detected using a plurality of detectors suitable for the corresponding intensity detections. In addition, the intensity directions can be performed at positions spaced apart from each other without affecting each other, to obtain enhanced detection accuracy.

Then, based on detection data from the first light detector 191a and the second light detector 191b during the image display operation, the correction circuit 91 is operable to correct respective light intensities of the R, G and B laser lights from the laser source 181 and white light from each of the white light sources 190 which are turned on by corresponding light source-driving circuit sections (not shown). This makes it possible to maintain an average light intensity in each of the light sources of the backlight illuminator 110, at a constant value. That is, the correction circuit 91 can correct a white level in conformity to a color balance required for an image to be displayed, to allow the image to be displayed with higher image quality. For example, this makes it possible to adjust a white balance in such a manner as to display intense black for a dark screen image, and stark white for a bright screen image.

As above, based on detection data from the first light detector 191a and the second light detector 191b, an average intensity in each of the laser source 181 and the white light sources 190 can be maintained at a constant value. This makes it possible to display an image in a wide color reproduction range, and emphasize white of an image which requires emphasizing white, so as to provide a liquid crystal display device capable of achieving higher image quality and more natural tone than ever before.

In the first light detector 191a, respective ON timings of the R light source, the G light source and the B light source constituting the laser source can be slightly delayed relative to each other to detect respective light intensities of R, G and B lights.

Although the second light detector 191b in the eighth embodiment is disposed in adjacent relation to each of the white light sources arranged side by side in a line on the side of the second principal surface 182a of the light-guiding plate 182, the present invention is not limited to this specific arrangement. For example, in the configuration of the liquid crystal display device 6 illustrated in FIG. 10A, the second light detector 191b may be disposed in adjacent relation to the white light source 180.

Although, in the liquid crystal display device 8 according to the eighth embodiment, laser light-detecting first light detector 191a and the white light-detecting second light detector 191b are disposed in adjacent relation to the laser source 181 and the white light source 190, respectively, the present invention is not limited to this specific arrangement. For example, the light detector may be disposed on the side of a back or front surface of the liquid crystal display panel 80, i.e., at a position where light intensities when laser lights and white lights are entered into the liquid crystal display panel 80, or light intensities when a viewer is visually checked, are measured. In this case, the respective intensities can be detected using the same light detector without preparing laser light-detecting first light detector 191a and the white light-detecting second light detector 191b separately.

Specifically, respective ON timings of the generation of white light by the white light source and the generation of laser light by the laser source can be slightly delayed relative to each other to detect respective intensities of thereof using the same light detector. In addition, respective ON timings of the R light source, the G light source and the B light source constituting the laser source can also be slightly delayed relative to each other to detect respective light intensities. In this manner, respective light intensity can be more uniformed while reducing the number of light detectors to be used.

In cases where it is necessary to widen a color reproduction range and emphasize a white level using a backlight illuminator having a laser source and a white light source, the liquid crystal display devices according to the sixth to eight embodiments have a significant effect of being able to display white with sufficient brightness, and provide a liquid crystal display device capable of achieving higher image quality.

In view of the above embodiments, the present invention can be summarized as follows: A liquid crystal display device of the present invention comprises: a light source section adapted to emit red light, green light and blue light; a liquid crystal display panel adapted to apply a voltage to liquid crystal thereof to display an image; and a drive control section adapted to drive the liquid crystal display panel, wherein: the liquid crystal display panel includes a plurality of pixels each made up of a first sub-pixel having a first color filter adapted to allow only any two of red, green and blue lights to pass therethrough, and a second sub-pixel having a second color filter adapted to allow only a remaining one of the red, green and blue lights to pass therethrough; the drive control section is operable to time-divide one frame of image into n pieces (wherein n is an integer of two or more), and apply voltages associated with respective images of the two lights, to the first sub-pixel alternately during every duration of the 1/n frame, while applying a voltage associated with an image of the remaining one light, to the second sub-pixel during a duration of the one frame of image; and the light source section is operable to emit the two lights alternately during every duration of the 1/n frame in synchronization with applying the voltages associated with the respective images of the two lights by the drive control section, while continuously emitting the remaining one light during the duration of the one frame of image.

In the above liquid crystal display device, a drive/display operation can be performed by switching between only any two of the three red, green and blue lights, so that a response speed required for the liquid crystal can be reduced to ⅔ as compared with the conventional field sequential driving scheme. This makes it possible to achieve an excellent moving image, for example, even in an OCB mode liquid crystal display panel having a response speed which is hardly adequate for the conventional field sequential driving scheme. In addition, the number of sub-pixels making up a unit pixel can be limited to only two, so that a resolution and an aperture ratio can be more improved than ever before. Particularly, in case of increasing the aperture ratio, a reduction in power consumption can be remarkably facilitated. Furthermore, the unit pixel made up of only two sub-pixels makes it possible to improve a fabrication yield of the liquid crystal display panels and achieve a reduction in cost.

Preferably, the number n for use in time-dividing the one frame of image for the first sub-pixel is two.

In this case, there is not any risk of significant reduction in light quantity of the two lights to be switched therebetween and drivenly displayed.

Preferably, the light source section is at least one selected from the group consisting of a laser source, a light-emitting diode, a field emission electron excitation luminescence light source, and an electroluminescence.

In this case, an optimal light source can be selected for each of the light sources of red light, green light and blue light. The field emission electron excitation luminescence light source means a light source utilizing field emission display (FED), which is capable of generating red light, green light, blue light or white light by selecting a fluorescent material.

Preferably, the light source section includes three laser sources adapted to emit red light, green light and blue light, respectively.

In this case, a laser source excellent in color purity may be used to significantly widen a color reproduction range. This makes it possible to achieve an image display operation capable of reproducing sharper and more natural tone.

Preferably, the two lights are red light and blue light, and the remaining one light is green light, wherein the laser source includes a red LD source, a blue LD source, and a green SHG-LD source.

In this case, the red LD source, the blue LD source and the green SHG-LD source may be used for obtaining red, blue and green with high color purity and excellent stability in light output.

Preferably, the green SHG-LD source is adapted to be driven by a pulse train, using a Q-switch.

In this case, a light intensity peak can be increased to obtain green light with large output and excellent stability in output, and achieve a highly reliable liquid crystal display device.

Preferably, the liquid crystal of the liquid crystal display panel is OCB mode liquid crystal.

In this case, an orientation of liquid crystal can be accurately controlled during a duration of one frame of image to perform the switching between the two light with a high degree of accuracy.

Preferably, the light source section is a backlight illuminator disposed on the side of a back surface of the liquid crystal display panel, wherein the liquid crystal display panel is illuminated from the side of the back surface thereof, with a planar light emitted from one principal surface of the backlight illuminator.

In this case, a flat panel-type liquid crystal display device with an adequate color reproduction range can be obtained, and used as a display device for large-screen thin televisions and personal computers.

Preferably, the backlight illuminator includes a flat plate-shaped light-guiding plate adapted to allow light entered from one edge surface thereof to be emitted from the one principal surface in a planar pattern.

In this case, light from the light source can be uniformly emitted to the liquid crystal display panel from one surface of the backlight illuminator.

Preferably, the light source section is a projection-type illuminator, wherein light emitted from the projection-type illuminator is entered into the liquid crystal display panel, and resulting transmitted light is projected onto a screen.

In this case, a front projection-type or rear projection-type projection liquid crystal display device can be achieved in an easy manner.

Preferably, the second sub-pixel further has a fluorescent material layer provided on the second color filter and adapted to absorb blue light emitted from the light source section to generate a green fluorescent light.

In this case, green light with excellent stability in light output can be obtained.

Preferably, a light quantity of the two lights is n times greater than that of the remaining one light.

In this case, there is not any risk that a light quantity of the two light to be switched therebetween and drivenly displayed is more reduced as compared with a light quantity of the remaining one light.

Preferably, an aperture ratio of the first sub-pixels is n times greater than that of the second sub-pixel.

In this case, there is not any risk that a light quantity of the two light to be switched therebetween and drivenly displayed is more reduced as compared with a light quantity of the remaining one light.

A liquid crystal display device of the present invention comprises: a light source section adapted to emit red light, green light and blue light; two liquid crystal display panels each adapted to apply a voltage to liquid crystal thereof to display an image; and a drive control section adapted to drive each of the liquid crystal display panels, wherein: the liquid crystal display panels including a first liquid crystal panel adapted to be illuminated with only any two of red, green and blue lights, and a second liquid crystal panel adapted to be illuminated with only a remaining one of the red, green and blue lights; the drive control section is operable to time-divide one frame of image into n pieces (wherein n is an integer of two or more), and apply voltages associated with respective images of the two lights, to pixels of the first liquid crystal panel alternately during every duration of the 1/n frame, while applying a voltage associated with an image of the remaining one light, to pixels of the second liquid crystal panel during a duration of the one frame of image; and the light source section is operable to emit the two lights to the first liquid crystal panel alternately during every duration of the 1/n frame in synchronization with applying the voltages associated with the respective images of the two lights by the drive control section, while continuously emitting the remaining one light to the second liquid crystal panel during the duration of the one frame of image.

The above liquid crystal display device employs the first liquid crystal panel adapted to be illuminated with only any two of red, green and blue lights, and the second liquid crystal panel adapted to be illuminated with only a remaining one of the red, green and blue lights. Thus, a response speed required for the liquid crystal can be reduced to ⅔ as compared with the conventional field sequential driving scheme. This makes it possible to achieve an excellent moving image, for example, even in an OCB mode liquid crystal display panel having a response speed which is hardly adequate for the conventional field sequential driving scheme. In addition, a need for providing sub-pixels corresponding to the respective colors can be eliminated, so that the number of unit pixels per liquid crystal panel can be increased to more improve a resolution and an aperture ratio than ever before. Further, the elimination of the need for providing sub-pixels makes it possible to improve a fabrication yield of the liquid crystal panels and achieve a reduction in cost. Furthermore, only the two liquid crystal panels for the three lights are enough to achieve the expected purpose. This can more facilitate a reduction in cost.

A liquid crystal display device of the present invention comprises a liquid crystal display panel, and a backlight illuminator adapted to illuminate the liquid crystal display panel from the side of a back surface thereof. The backlight illuminator includes a laser source adapted to generate at least red light, green light and blue light, and a white light source adapted to generate white light. The backlight illuminator is operable, when the liquid crystal display panel displays an image which requires emphasizing white, to increase an output intensity of the white light source.

In above liquid crystal display device, the laser source adapted to generate red light, green light and blue light is employed to allow a color reproduction range of images to be widened, and the white light source is employed to allow white when it is desired to emphasize a white level to be displayed with sufficient brightness. Thus, a higher quality image can be displayed as compared with a type using only a laser source.

Preferably, the white light source is at least one selected from the group consisting of a light-emitting diode, a fluorescent display tube, a field emission electron excitation luminescence light source, and an electroluminescence each of which is adapted to generate white light.

In this case, at least one selected from the group consisting of a light-emitting diode, a fluorescent display tube, a field emission electron excitation luminescence light source, and an electroluminescence is employed as the white light source. Thus, an optimal light source to an intended liquid crystal display device can be selected.

Preferably, the light-emitting diode comprises a blue light-emitting diode, and a fluorescent material adapted to convert blue light generated from the blue light-emitting diode, into white light.

In this case, an LED adapted to generate white light converted from blue light by a fluorescent material is employed. This makes it possible to suppress fluctuation in white balance.

Preferably, the above liquid crystal display device further comprises a drive control section adapted to drive the liquid crystal display panel and the backlight illuminator. The drive control section includes a brightness recognition circuit operable to recognize a white level of an image to be displayed. The drive control section is operable, based on a result of recognition by the brightness recognition circuit, to instruct the backlight illuminator to increase an output intensity of the white light source.

In this case, the brightness recognition circuit pre-recognizes whether an image has a white level to be emphasized. If the brightness recognition circuit recognizes that the white level of the image should be emphasized, it drives the backlight illuminator to increase an output intensity of the white light source, so that white can be displayed with sufficient brightness during an image display operation instructed to emphasize the white level.

The drive control section is operable, when the brightness recognition circuit recognizes that a ratio of a white area in an image to be displayed, to a total area of the image, is equal to or greater than a given value, to increase an output intensity of the white light source.

In this case, the necessity of increasing the output intensity of the white light source can be determined based on the comparison with the predetermined given value. This makes it possible to quickly instruct the drive control section to controllably turn on the white light source.

Preferably, the backlight illuminator further includes a light-guiding plate adapted to guide laser light from the laser source and white light from the white light source, and output the laser and white lights from a first one of opposite principal surfaces thereof in a planar pattern, wherein laser light from the laser source is entered into the light-guiding plate from one edge surface thereof.

In this case, laser light and white light can be emitted from the first principal surface of the light-guiding plate, i.e., from the same surface. This makes it possible to prevent uneven color so as to obtain illuminating light with a uniform brightness distribution.

Preferably, white light from the white light source is entered into the light-guiding plate from the one edge surface thereof.

In this case, white light from the white light source is entered from the one edge of the light-guiding plate, as with the laser light. Thus, a thin-type backlight illuminator can be achieved.

Preferably, white light from the white light source is entered into the light-guiding plate from the other, second, principal surface thereof.

In this case, white light from the white light source is entered from the second principal surface of the light-guiding plate. Thus, for example, a large number of white light-emitting diodes can be arranged side by side to more uniformly display a white-emphasized screen image with higher brightness.

Preferably, the light-guiding plate includes a reflection layer provided on the second principal surface, and adapted to reflect laser light sent from the laser source and entered from the one edge surface, toward the first principal surface, and allow the white light from the white light source to be transmitted therethrough.

In this case, the white light from the white light source can be entered from the second principle surface of the light-guiding plate, and emitted from the second principle surface, while uniformly reflecting laser light from the laser source.

Preferably, the white light source includes a plurality of white light source members arranged in such a manner that an in-plane distribution relative to the second principal surface of the light-guiding plate becomes uniform.

In this case, a white-emphasized screen image can be displayed more uniformly with higher brightness.

Preferably, the liquid crystal display device further comprises a light detector operable to detect respective light intensities of laser light from the laser source and white light from the white light source, and a correction circuit operable, based on detection data from the light detector, to correct a light intensity of at least one of laser light from the laser source and white light from the white light source.

In this case, based on detection data from the detector, an average light intensity of laser light and white light can be maintained at a constant value. This makes it possible to achieve a liquid crystal display device capable of displaying images while reliably improving image quality based on the laser source and emphasizing white based on the white light source, stably over a long period of time. For example, the light detector may be disposed on the side of a back or front surface of the liquid crystal display panel, i.e., at a position where light intensities when laser light and white light are entered into the liquid crystal display panel, or light intensities when a viewer is visually checked, are measured. In this case, for example, respective ON timings of the generation of white light by the white light source and the generation of laser light by the laser source can be slightly delayed relative to each other to detect respective intensities of thereof using the same light detector.

Preferably, the light detector includes a first detector operable to detect a light intensity of laser light from the laser source, and a second light detector operable to detect a light intensity of white light from the white light source.

In this case, respective light intensities of the laser source and the white light source can be detected individually. Thus, one of the two detectors can be selected depending on suitability for detection of respective light intensities.

Preferably, the first light detector is disposed at the other edge surface of the light-emitting plate, and the second light detector is disposed in adjacent relation to the white light source.

In this case, the intensity directions can be performed at positions spaced apart from each other without affecting each other, to obtain enhanced detection accuracy.

### INDUSTRIAL APPLICABILITY

The liquid crystal display device of the present invention can use a liquid crystal having a lower response speed as compared with the conventional field sequential driving scheme. For example, an OCB mode liquid crystal display panel can be used, and a resolution and an aperture ratio can be increased while facilitating a reduction in power consumption, which is useful in the field of display devices for thin televisions and others.

In the liquid crystal display device of the present invention, a white light source can be used for an image which requires emphasizing white, to emphasize white, and a higher quality image can be displayed with the addition of widening of a color reproduction range and emphasis of a white level based on a laser source, which is useful in the field of display devices for thin televisions and others.

1-13. (canceled)

14. A liquid crystal display device comprising:
a liquid crystal display panel; and
a backlight illuminator adapted to illuminate said liquid crystal display panel from the side of a back surface thereof, said backlight illuminator including a laser source adapted to generate at least red light, green light and blue light, and a white light source adapted to generate white light, said backlight illuminator being operable, when said liquid crystal display panel displays an image which requires emphasizing white, to increase an output intensity of said white light source.

15. The liquid crystal display device as defined in claim 14, wherein said white light source is at least one selected from the group consisting of a light-emitting diode, a fluorescent display tube, a field emission electron excitation luminescence light source, and an electroluminescence each of which is adapted to generate white light.

16. The liquid crystal display device as defined in claim 15, wherein said light-emitting diode comprises a blue light-emitting diode, and a fluorescent material adapted to convert blue light generated from said blue light-emitting diode, into white light.

17. The liquid crystal display device as defined in claim 14, which further comprises a drive control section adapted to drive said liquid crystal display panel and said backlight illuminator, said drive control section including a brightness recognition circuit operable to recognize a white level of an image to be displayed, said drive control section being operable, based on a result of recognition by said brightness recognition circuit, to instruct said backlight illuminator to increase an output intensity of said white light source.

18. The liquid crystal display device as defined in of claim 17, wherein said drive control section is operable, when said brightness recognition circuit recognizes that a ratio of a white area in an image to be displayed, to a total area of said image, is equal to or greater than a given value, to increase an output intensity of said white light source.

19. The liquid crystal display device as defined in claim 14, wherein said backlight illuminator further includes a light-guiding plate adapted to guide laser light from said laser source and white light from said white light source, and output said laser and white lights from a first one of opposite principal surfaces thereof in a planar pattern, wherein laser light from said laser source is entered into said light-guiding plate from one edge surface thereof

20. The liquid crystal display device as defined in claim 19, wherein white light from said white light source is entered into said light-guiding plate from said one edge surface thereof

21. The liquid crystal display device as defined in of claim 19, wherein white light from said white light source is entered into said light-guiding plate from the other, second, principal surface thereof

22. The liquid crystal display device as defined in claim 21, wherein said light-guiding plate includes a reflection layer provided on said second principal surface, and adapted to reflect laser light sent from said laser source and entered from said one edge surface, toward said first principal surface, while allowing said white light from said white light source to be transmitted therethrough.

23. The liquid crystal display device as defined in claim 21, wherein said white light source includes a plurality of white light source members arranged in such a manner that an in-plane distribution relative to said second principal surface of said light-guiding plate becomes uniform.

24. The liquid crystal display device as defined in claim 19, which further comprises:
a light detector operable to detect respective light intensities of laser light from said laser source and white light from said white light source; and
a correction circuit operable, based on detection data from said light detector, to correct a light intensity of at least one of laser light from said laser source and white light from said white light source.

25. The liquid crystal display device as defined in claim 24, wherein said light detector includes a first detector operable to detect a light intensity of laser light from said laser source, and a second light detector operable to detect a light intensity of white light from said white light source.

26. The liquid crystal display device as defined in claim 25, wherein:
said first light detector is disposed at the other edge surface of said light-emitting plate; and
said second light detector is disposed in adjacent relation to said white light source.
